(19) United States
(12) Patent Application Publication
(10) Pub. No.: US 2024/0170904 A1
(43) Pub. Date: May 23, 2024

(54) CABLE PROCESSING COMPRISING INFEED AND OUTFEED

(71) Applicant: Schleuniger AG, Thun (CH)

(72) Inventors: Michael ZBINDEN, Thun (CH); Willi BLICKENSTORFER, Stallikon (CH)

(73) Assignee: Schleuniger AG, Thun (CH)

(21) Appl. No.: 18/550,754

(22) PCT Filed: Mar. 17, 2021
(86) PCT No.: PCT/IB2021/052229

§ 371 Date: Sep. 27, 2023

(51) Int. Cl. H01R 43/28; B65H 51/08; B65H 51/18

(52) U.S. Cl. CPC H01R 43/28; B65H 51/08; B65H 51/18; B65H 2701/341

(57) ABSTRACT

The invention relates to a cable-processing system comprising: a cable-processing machine (90), especially for automatically processing cable ends of long and/or heavy, relatively flexurally rigid pre-cut cables (80) in at least one cable-processing station (70a, 70b) of the cable-processing machine (90); and a cable transport device (10). The cable transport device (10) is designed with: a cable conveying device (320a, 320b) for transporting at least one of the cable ends (81) of the cable (80) into the at least one cable-processing station (70a, 70b); and a suspension transport device (50) which is designed to transport a cable offcut (80c, 80c1, 80c2) of the cable (80). This cable offcut (80c, 80c1, 80c2) is transported in a suspended manner, for example as a suspended cable wrap (80c). According to the invention, the suspension transport device (50) has at least one guide (51a, 51b, 51c, 51d) and a plurality of suspension transport units (53). These suspension transport units (53) can be displaced in the guide (51a, 51b, 51c, 51d) and are designed as suspensions for the cable offcut (80c, 80c1, 80c2). The suspension transport units (53) are designed in such a way that a cable offcut (80c, 80c1, 80c2) suspended therefrom can be rotated about a vertical axis with or on the suspension transport unit (53).

This application is a National Stage completion of PCT/IB2021/052229 filed Mar. 17, 2021.

### FIELD OF THE INVENTION

The invention relates to a cable processing system according to the claims, comprising a cable processing machine for automatically processing at least one cable end of an in particular heavy and/or relatively flexurally rigid cable in at least one cable processing station, wherein the cable is especially provided as a pre-cut cable piece of a length of more than approx. 1.5 m, in particular wrapped to form a cable wrap starting at a length of more than approx. 2.5 m. The invention likewise relates to a corresponding method for automatically processing cable ends of heavy, flexurally rigid cables (80) according to the claims.

### BACKGROUND OF THE INVENTION

Stating at a certain length, cables are coiled to form a cable wrap or coil, in order to simplify the handling and transport thereof. In terms of the present invention, the cable wraps are thereby not cable drums, which provide the cables quasi endlessly and which are then cut only in the course of the processing, but coils or wraps of pre-cut cable pieces, which are already cut to an essentially final length. In the case of these, at least one of the cable ends has to still be processed, for example with known cable processing steps, such as, e.g., stripping, core separation, removing insulation, twisting, crimping, splicing, labeling or marking, plug assembly, etc.

In DE 10 2016 116 453, the cable wraps are supplied in special cable boxes for a respective one of the cables.

For short and thin cables, the U.S. Pat. Nos. 5,125,154 or 5,152,395 shows a machine, in the case of which a complete box comprising cables, which are in each case suspended therein individually on transport units, moves through a machine during a cable processing.

The CN 208485490 proposes a wire bundle loop for suspending the wire bundle, which has an elongate hanger body and several self-supporting parts, wherein the upper part of the several self-supporting parts is fastened so as to intersect with the hanger body, so that the plurality of the cantilever parts are arranged equidistantly along the longitudinal direction of the cantilever body.

EP 2 565 992 shows a means for circularly feeding cable ends of a cable loop to confectioning units. Several holding elements are used thereby, between which the cable loop is stretched. Only a small base is thereby advantageously required with a clocked rotary transfer or a carousel, respectively. EP 1 073 163, EP 2 088 649, WO 99/14829, DE 19844416, or EP 0 271 742 also show known means for transporting cable loops, as well as EP 2 421 102 shows an untwisting means.

In a different technical field, KR 100900668 shows a transport of wire rolls through a conveying device equipped with a C-hook.

It is a disadvantage of this known solution that an automatic supply of the cables in practice often causes problems, especially when a reliable processing of the cables with low manufacturing tolerances is required.

Especially in the case of heavy, relatively flexurally rigid cables, such as mentioned above (e.g. charging cables for electric vehicles, . . . ), it is thereby a problem that the cable handling is even more difficult. For example, cables of this type cannot readily be twisted as strongly as thinner cables. A rotation of the cable about the longitudinal axis thereof is thus often required, for instance during the cable end processing, in order to orient the cores of the cable to match the processing tool (see EP2871732). Something like that can cause problems with heavy, relatively flexurally rigid cables, especially when the cable end protrudes from a cable wrap, in particular when this protruding piece is relatively short but stiff. In the case of boxes or carrier plates, as shown in the prior art, something like that can result, for instance, in tensions, which can lead to blockages, inaccurate positionings, or rotations, etc.

### SUMMARY OF THE INVENTION

It is thus the object of the present invention to create a device, which does not have the above-mentioned disadvantages and which still provides for a low-tension suspension of the wrap, even if the cable end is rotated about its longitudinal axis.

The object is solved by means of the features of the independent claim. Advantageous further developments are specified in the figures and in the dependent patent claims.

Aside from the fact that something like that would not be practicable in the case of heavy, thick and flexurally rigid cables, cable processing systems of this type are in need of improvement with respect to efficiency, accuracy, and reliability in the cable end processing. For example, it is also a disadvantage of these known solutions that especially rigid or stiff cables of this type cannot be handled in the same way as common standard cables. In particular, an improved cable processing system is to be provided, which can handle heavy, relatively flexurally rigid cables, which are present as cable wraps. An accurate and reliable cable end processing of such cables is to preferably be provided thereby, even if this requires a rotation or movement of the cable during or prior to the processing.

It is thus an object of the present invention to provide a cable processing system, which does not have the above-mentioned disadvantages and which in particular provides a quick and reliable cable processing, which preferably also does not depend on a permanent presence and the skill of a worker. The sequences of the cable processing should preferably also be capable of being integrated into a higher-level, automated, electronic production or factory management system, thus, e.g., designed for Industrie 4.0.

The object is solved by means of the features of the independent claim. Advantageous further developments are described in the figures and in the dependent patent claims.

According to the invention, a cable processing system is provided. This system comprises a cable processing machine comprising a machine controller for automatically processing ends cable of heavy, relatively flexurally rigid, pre-cut cables on a frame. The system according to the invention is thereby formed especially in order to be loaded with cables in the form of pre-cut cable pieces, on which at least one, optionally also both cable ends are processed. The cables can thereby be present especially as cable pieces or cable products of a defined cable length of more than approx. 1 meter, or in the case of cables, which are longer than 1.5 m (e.g. longer than 2 m, 5 m, 10 m, 25 m, 50 m, or more), respectively, the cables can also be present so as to be formed into a cable arch or a cable loop, respectively, or into a cable wrap comprising at least one, preferably several rotations or can be brought into such a shape and can be provided. On their way through several cable processing stations, these wraps are transported along, wherein the cable ends or cable end regions thereof, respectively, are held approximately in a straight manner and are supplied to a cable processing station of the cable processing machine. Cable ends thereby does not mandatorily refer to only the blunt end of a cut surface of the cable, but to a cable end region, thus, e.g., a region at the end of the cable, in particular of, e.g., up to 5 cm or 10 cm or up to approximately 30 cm or 50 cm.

The cable processing system thereby has a cable transport device, which is formed with a cable conveying device for transporting at least one of the cable ends of the cable into the at least one cable processing station. The cable transport device can thereby be equipped with at least one cable conveying device, which is formed as multiple storage and which has several cable holders for a cable end of the cable. It is formed especially as actively conveying cable conveying device, in order to actively convey several of the cables, thus to move the cable with an active mechanism in each case, in order to continue to move the cables contained in the multiple storage and with respect to the latter. For example, a cable conveying device in the form of a conveyor belt, a walking beam conveyor, a chain conveyor for preferably separable chains with quick fastener in the segments, etc.—especially as described and/or outlined below.

In particular in the cable processing machine or on and/or between the cable processing stations, respectively, the cable or cable end, respectively, can thereby also be moved by means of a cable transport device, which is formed with at least one frame-supported gripper, which can be displaced by means of a transport system, for transporting the cable end through the cable processing machine or cable processing stations, respectively. The remaining portion of the cable (e.g. as wrap) is thereby moved along accordingly with the transport system or gripper, respectively, preferably largely synchronously with the movements for the cable end and the movements for the remaining portion of the cable.

The cable transport device further has suspension transport means, which is formed for transporting the remaining portion of the cable outside of the cable end—also referred to as cable offcut or cable body of the cable. The transport of this cable offcut thereby takes place in a suspended manner, especially as suspended cable wrap or coil. The cable is to thus be considered to be divided into longitudinal sections, comprising a first cable end and corresponding cable end region of up to, e.g., approx. 50 cm, which cable end is processed, as well as the remaining portion of the cable as cable offcut or cable body, whereby the cable offcut, provided that it is sufficiently long, is provided as cable wrap or cable coil, which saves space and can reduce the risk of entanglements or interlocking.

According to the invention, the suspension transport means has at least one guide and several suspension transport units, which can be displaced in the guide, thus are movable, e.g. formed as carriages, slides, rollers, or sliding bodies in the guide, so that they can be moved smoothly along the guide. This guide can be floor- or ceiling-supported or can be attached to a frame of the cable processing machine and/or of the multiple storages, respectively. The guide can especially also be formed as network of several guides, between which the suspended transport means can be transferred or forwarded, respectively. The suspended transport units are formed, e.g., as suspensions for the cable offcut. The suspended transport units are thereby designed in such a way that a cable offcut suspended thereon can be rotated about a vertical axis with or on the suspension transport unit. The suspended cable can thus in particular be rotated with respect to the guide or is pivotably mounted at least about the vertical axis, respectively. For example, a low-tension transport of the cable wrap can thus take place, especially also when the cable end has to be rotated (about the cable axis and/or optionally also orthogonally thereto) in/for a cable processing station and/or also when the cable end is moved unevenly/asynchronously. For example, an interlocking or jamming of the cables with one another can thus be avoided.

The machine can thereby especially have an input side for a receptacle of the cables to be processed, as well as an output side for a delivery of the processed cables. A processing of the cable takes place between the input side and the output side, preferably—but not mandatorily—a processing of the cable ends, e.g. by means of a removal of insulation, twisting, bending, crimping, assembling, confectioning, etc., which takes place by means of at least one, preferably by means of at least two or more frame-supported cable processing stations. The cable processing machine can thereby be embodied on a frame, which means that the cable processing stations are combined as unit in a machine, rather than, for instance, standing individually and scattered in a factory building. The cable processing stations can be interconnected, for example, as modules and/or by means of a frame construction to form a machine and can preferably also be combined under a common housing.

In the cable processing machine, the cable transport device preferably has at least one likewise frame-supported, displaceable gripper for the cable. On the one hand, such a gripper is formed with a subregion formed as gripping system for releasably holding a cable or cable end, for example with a type of pincer grippers comprising movable jaws or another means for the releasable positive and/or non-positive clamping of a cable, a vacuum holder, or an adhesive, magnetic, or gravitational, releasable holding means—with or without a corresponding sensor system for determining whether and/or how a cable is currently held. The gripper is thereby designed to be displaceable, which means that it is formed to move the cable with respect to a machine base, thus for example the frame, the cable processing stations and/or the input or output side. The transport system and/or the displaceable gripper thus has at least one rotative or linear movement axis. According to the invention, at least one of the cable processing stations can have a (station) gripper or a specific cable rotating means, by means of which the cable end can be rotated about its axis, in order to attain a desired alignment of the cable end or if something like this is required for processing purposes. The cable end can optionally also be rotated or pivoted, respectively, normally to the cable axis.

At least one of the cable processing stations is thus preferably formed to rotate the cable end during or for the processing thereof, in particular about the longitudinal axis thereof, specifically for preparing or performing a processing of the cable end. This rotation can take place, for example, by means of a station gripper comprising a rotary drive. A sensor and/or a camera is typically provided for detecting a rotational position or orientation of the cable end, so that, with the rotation, the cable end can be aligned or oriented according to a specification, oriented with the single cores of the cables so as to match the processing tool in the cable processing station.

The cable conveying device formed as multiple storage can thereby be formed with cable holders, for example as clamp, support, compartment, or separating web (pair) for one of the cables or one of the cable ends, respectively, which are moved by means of the conveying device in the multiple storage, especially as will be described in an exemplary manner hereinafter. Two cable holders, which are spaced apart from one another, are preferably used for a cable, preferably with the one cable holder thereof embodied as clamp, and the other one as support. A clamp is thereby, for example, an element, which clamps the cable on a subregion of its circumference between two elastic, essentially parallel parts, which partially enclose the cable, with a force. A support can be formed, for example, as a recessed shape, in which the cable comes to rest due to the force of gravity, and the cable is preferably held laterally in a defined position region by means of lateral separating webs, without thereby clamping the cable between the separating webs with a force.

The cable processing machine is thereby preferably formed in such a way that thin cables, standard cables, and thick, flexurally rigid cables can be processed with the same machine, in particular without having to make significant conversions on the machine. In a preferred embodiment, short cable pieces of, e.g., several 10 cm, as well as long cables of several meters can thereby also be processed by means of the same machine, especially in that, aside from the multiple storage for the cable ends, a suspended transport means of the cable processing machine is additionally used for the longer cables. For example, a multiple storage according to the invention can also be formed in such a way that limp cables can also be provided or conveyed therewith, respectively.

At least one of the suspended transport units is thereby preferably formed with a carriage (or slide, glider trolley, . . . ) matching the guide, so that said suspended transport unit can be moved along the guide. The suspended transport unit can further preferably show a counter surface for a follower of a transport unit, in order to be moved by it. The vertically rotatable storage can be provided by means of a rotatable storage of a suspended fastener, e.g. by means of a sliding or ball bearing. The suspension fastener can in particular be embodied in a hook-shaped manner, with a carabiner or as a pin (comprising lock), in order to provide the cable so as to be suspended thereon. A shaped element, e.g. made of plastic or metal, can preferably also be capable of being attached to this suspension fastener, in order to be able to suspend the cable in an advantageous manner.

The suspended transport unit is preferably formed with a shaped element, which is formed with a curved region and a region at least partially forming a U-profile in such a way that a subregion of the cable offcut can be suspended thereabove, thus, e.g., in such a way that the curved region has an at least similar radius as a loop or a wrap of the cable, so that it is supported fully and securely.

Alternatively or additionally, the shaped element is formed with a holding region in such a way that the cable offcut can alternatively be fixed on its non-processed cable end so as to be suspended vertically (or perpendicularly) (e.g. by means of clamping, clipping in, stapling, frictional fixing, etc.), especially for cables, which are too short to form a wrap.

The shaped element can thereby preferably be formed in such a way that the cable offcut can be fixed to the shaped element on at least one cable section by means of a fastening element, in order to prevent a slipping, for example by means of a clip, rubber band, cable tie, hook-and-loop fastener, etc., which can be fastened through or around the shaped element.

The shaped element can be formed in such a way that it can be replaceably attached to the suspension fastener of the at least one suspension transport unit, so that either the suspension fastener itself or one of different shaped elements can be used—in each case matching the cable.

The at least one suspended transport unit is preferably formed with a suspension fastener, on which the cable offcut can be suspended directly or indirectly. Directly means thereby that the cable or the cable wrap is suspended on the suspension fastener without intermediary intermediate element, e.g. a wrap is suspended above the shaped element or the hook of the suspension fastener. Indirectly means that an intermediate element, such as a hook, an eye, a rope, cable tie, etc., is attached between cable and suspension fastener. The suspension fastener can thereby in particular be designed in such a way that the vertical axis of the rotatability essentially corresponds to an axis of symmetry of the cable offcut or of the wrap, respectively, especially for short cables fastened in the clip.

The suspension fastener can preferably be formed in such a way that the cable offcut can be indirectly fastened thereto by means of a releasable fastening unit, e.g. by means of a cord, a rope, carabiner, pin, cable tie, etc., whereby the most diverse configurations can be attained, and/or the vertical rotatability can be attained by means of this fastening unit. E.g., a piece of rope can thereby be wrapped and/or knotted around the cable or the cable wrap, so that the cable is suspended on the rope. This rope with cable suspended thereon can then be attached to the suspension fastener, e.g. to a hook, carabiner, or a pin comprising a lock, etc.

The cable offcut is preferably formed as suspended cable wrap, e.g. a coil comprising at least one winding of the cable, a coiled cable, a cable inserted into long rolls or into nice bays or into twisted bays or as a cable twisted in the shape of an eight, etc. This cable can be transported in a compact and stable manner and can often also be further processed directly or distributed in this shape. Such a cable wrap can be embodied to be essentially round, in particular essentially circular or oval. The cable wrap can preferably also be held together or bound together, respectively, in its cross section in several places along its circumference, e.g. by means of cable ties, adhesive tape, film, wire, or the like. It in particular has at least one complete winding of the cable, preferably several windings. At least one cable end or cable end region of the cable wrap, which is to be processed, thereby protrudes or can be removed from the wrap, so that it can be inserted into the multiple storage for the cable ends (preferably in at least approximately stretched position), while the cable wrap is suspended on the suspension fastener.

At least one active transport means, which is arranged and formed so as to move at least one suspension transport unit in the guide, is preferably provided on the cable processing machine in the region of the guide. This transport means has at least one follower, which is formed so as to match a counter surface on the suspension transport unit, so that the suspension transport unit can be moved by means of the transport means. The transport drive for moving this follower is in particular arranged parallel to the guide at least in pieces, so that the suspension transport units can be conveyed along the guide. The transport drive is in particular formed in such a way that it moves synchronously or at an average speed of the transport of the cable end of the cable suspended on the moved suspension transport unit, especially following the movement of the cable conveying device and/or of the grippers with their corresponding transfer mechanisms.

A multiple transport means is preferably arranged on the cable processing machine on an input side of the cable processing machine, in the region of the transporter guide. An engagement of the multiple transport means on at least one suspension transport unit with the guide of the multiple suspension transport means thereby takes place in particular during the docking of a multiple storage or of an extra carriage as multiple suspension transport means, so that the suspension transport units can be conveyed. Suspension transport units suspended, e.g. in a guide on a mobile carriage, can thus be docked, with the carriage brought to the cable processing machine, in such a way that the carriage can convey the suspension transport units by means of the multiple transport means on the cable processing machine into the machine (or vice versa, respectively).

The multiple transport means preferably has several followers for at least one of the suspension transport units each and is formed in particular with a revolving belt or a chain, respectively, a twin belt conveyor, a conveyor belt, a walking beam conveyor, by means of which the suspension transport units can be conveyed in the guide. A walking beam is thereby a means, which in each case provides a piecewise, linear propulsion via followers, in particular as will be described below on the basis of an exemplary embodiment. Due to the simultaneous movement of several suspension transport units, the movement of the cable offcuts suspended thereon can simply be synchronized with the movement of the corresponding cable end regions in the cable conveying device.

The suspension transport means is preferably formed in such a way that at least one of the suspension transport units is pushed further. By means of another one of the suspension transport units. On the output side of the cable processing machine, the suspension transport units can, for example, mutually insert themselves one after the other with completely produced cables into a guide, which guide is provided for removal (e.g. on a carriage).

In an alternative embodiment, the transport means is preferably formed in a passive manner, wherein the suspension transport units can be pulled along by the cable conveying device or by grippers of the cable processing machine, so that the suspension transport units passively trail a movement of the cable ends. A passive transport means of this type could be designed, for example, in the form of a spring, in particular a constant force roller spring, wherein the suspension transport units push one another further, similarly the rounds in the magazine of a gun.

The transport means is preferably formed with several adjacent transport means, which are in particular designed in such a way that the displacement region thereof overlaps, and both adjacent transport means simultaneously or jointly, respectively, come into operative connection with at least one of the suspension transport units in the region of this overlap. In particular one of the cable processing stations can thereby comprise respective corresponding station transport means, the displacement region of which overlaps with that of an adjacent cable processing station, so that an essentially continuous further transport can take place via several cable processing stations and/or guides.

The guide or the transport means (optionally together with at least one partial piece of the guide) preferably protrudes from the input side and/or from the output side of the cable processing machine in such a way that the cable offcut can be suspended in the suspension transport unit or can be detached therefrom, respectively, and/or the suspension transport unit can be inserted into the guide or can be pushed out, respectively, or pulled out from it, respectively. In particular a peripheral loading and/or unloading of the cable processing machine is thus also possible during the operation, either manually or automatically.

In one embodiment, the guide is preferably designed in such a way that empty suspension transport units can be guided back to the starting point again, thus a revolving operation of the suspension transport units takes place. For this purpose, the guide can be designed as infinite loop, e.g., in the shape of an oval, and/or the suspension transport units can be moved with the help of lifts between different guides, e.g., in that a first guide is provided for an advance during the cable processing, and a second guide is provided for a return of unloaded suspension transport units.

The cables can preferably be supplied to the cable processing machine so as to be suspended on a replaceable extra carriage, which extra carriage can be docked in such a way that a delivery of the suspension transport units from a guide on the extra carriage into the guide of the cable processing machine can be performed. The cable ends of these cables can thereby be introduced into a cable conveying device on the cable processing machine, e.g. on the locally cable processing machine by a worker or robot. The cable conveying device can in particular be a firmly installed part of the cable processing machine or a multiple storage, which is permanently docked thereto (thus beyond a change of the extra carriages).

For a conveyance of the cable offcut (which is provided as wrap belonging thereto with free cable ends), the cable processing system preferably has at least one floor- or ceiling-supported, mobile multiple storage or extra carriage (e.g. at, on, or as transporter, which can be moved independently of the cable processing machine and which is in particular formed as carriage, trolley, or gondola), outside of the cable processing machine. It can be docked to the cable processing machine in a defined position in order to feed the cables in or out as a wrap in a suspended manner, especially on the input side or the output side. The multiple storage and/or extra carriage can thereby comprise at least one corresponding guide for the suspension transport units, which guide is designed in such a way that, when the multiple storage is docked, the suspension transport unit can be delivered to the cable processing machine between the guide of the multiple storage or extra carriage and the guide. For example, only one extra carriage can thus be brought from or to the cable processing machine by means of a guide, on which the cables are suspended. The respective cable ends can then be inserted into a corresponding local multiple storage on the machine on location.

The multiple storage is preferably formed with cable holders on the multiple storage, into which at least one cable end of a corresponding cable is inserted in each case, and wherein, aside from a transfer of the suspension transport unit, a transfer of the at least one cable end assigned to this wrap transport unit also takes place between multiple storage cable processing machine.

The multiple storage is preferably formed as cable conveying device, which has several cable holders. At least one of the cable holders can thereby have at least one web or follower, respectively, and/or can be formed as support and/or as clamp. In particular, one clamp and one support can preferably in each case be arranged in parallel on one or two belts or chains, which run synchronously to one another, and these clamps can have elastic elements, the preloading of which can preferably be set, and which are fastened in receptacles, which can be guided through guides along the conveying direction of the belts. The cable ends or cable end regions, respectively, can thus be transported reliably.

The cable processing machine is preferably formed with cable holders (e.g. preferably formed as conveying means), wherein at least one of the provided cable ends of a corresponding cable can be inserted into these cable holders on the cable processing machine by means of a suspension transport unit of the docked multiple storage or extra carriage, in particular manually or automatically.

In one embodiment, a firmly mounted multiple storage and a firmly mounted suspension transport means is preferably attached to the cable processing machine, and the cable transport device is formed in such a way that the cables can be suspended on the firmly mounted suspension transport means, and the cable ends or the cable end region of these cables, respectively, can be inserted or clamped, respectively, into the cable holder of the multiple storage or of the extra carriage. The cables can thus be fed in or out, respectively, locally on the machine by a worker (or robot).

The cable transport device preferably has at least one frame-supported, displaceable gripper for the cable in the cable processing machine, and the cable transport device is equipped with a cable conveying device, which is formed as multiple storage and which has several cable holders. At least one of the grippers is thereby in particular formed as delivery gripper, to remove one of these cables after the other from the respective cable holder and to supply it to at least one further gripper as transfer gripper and/or to one of the cable processing stations. The transfer grippers can thereby be formed so as to be capable of being moved by means of a frame-supported transfer mechanism in order to perform a delivery of the cable from one cable processing station into another cable processing station.

The cable processing machine is preferably formed with at least one gripper as delivery gripper, which can preferably be moved with the help of a frame-supported transfer mechanism. It is formed and arranged so as to remove one of these cables after the other from the respective cable holder and to supply it to at least one of the cable processing stations and/or to a further gripper. This further gripper is formed so as to be capable of being moved by means of a further frame-supported transfer mechanism in order to perform a delivery of the cable into one of the cable processing stations.

The invention analogously relates to a method for automatically processing heavy, long and/or relatively flexurally rigid cables in a cable processing machine. This method comprises a provision of the cable in suspended form on a suspension transport unit of a suspension transport means, in particular as cable wrap, which saves space, e.g. and which can prevent an interlocking of the cables.

A movement of the suspension transport unit in at least one guide or a network of several guides through the cable processing machine follows. The method also comprises a processing of at least one cable end of the cable in at least one cable processing station of the cable processing machine. This takes place by means of a conveying of the cable by means of a cable conveying device and/or of at least one gripper for transporting at least one of the cable ends or cable end regions of the cable, respectively.

According to the invention, a storage of the cable, which is rotatable about a vertical axis, thereby takes place with or on the suspension transport means, so that the cable can compensate for mechanical tensions caused by the processing.

The rotatable storage preferably takes place by means of a suspension fastener on a suspension transport unit, which can be displaced in a guide, of the suspension transport means, on which suspension fastener the cable is suspended.

The provision of the cable preferably takes place locally on the cable processing machine by means of a suspension of the cable on a suspension fastener of the suspension transport unit, for example by means of a rotatable hook, a carabiner, a rope, a cord, a pin, or on a shaped element attached to the suspension fastener.

The provision of the cable preferably takes place in suspended form of several cables on a respective suspension fastener of the suspension transport unit, wherein the suspension fasteners are provided in a guide on a mobile carriage, and a docking of the carriage to the cable processing machine takes place.

The provision of the cable preferably takes place with an insertion of the cable end or cable end region of the cable, respectively, into a respective cable holder, in particular into a multiple storage.

In one embodiment, the insertion of the cable end or cable end region of the cable, respectively, preferably takes place locally on cable holders on the cable processing machine, so that only the cable wraps have to be transported, but which can also be suspended at a distance from the machine.

In one embodiment, the insertion of the cable end or cable end region of the cable, respectively, preferably takes place separately from the cable processing machine on cable holders on the carriage, so that this can take place beforehand and at a distance from the machine.

The active movement of the cables preferably takes place in the suspension transport means, preferably by means of an electric or pneumatic drive, by means of a delivery of a movement from a drive of the cable processing machine to the suspension transport means, or by means of a constant force spring, so that a reliable conveying is ensured.

In other words, the invention also relates to a method for rotating a cable of a length of more than approximately 1.5 about meters, an essentially horizontal axis in a cable processing station of a cable processing machine. This comprises a gripping of a cable end or cable end region of the cable, respectively, as well as a rotation of the cable end into a provided position. According to the invention, a suspended provision of the remaining portion of the cable is performed outside of at least one of the cable end regions, preferably as cable wrap, on a suspension transport unit of a suspension transport means. The cable is thereby provided so as to be rotatable about a vertical axis with respect to the suspension transport unit. A compensation of tensions can thus in particular take place by means of the horizontal rotation of the cable end by means of a vertical rotational movement of the remaining portion of the cable on the suspension transport means.

The international patent application PCT/IB2021/052219, which was filed on the same day by the same applicant and with the same main inventor and which likewise relates to a “Cable Processing Comprising Infeed and Outfeed”, is also incorporated by reference. Especially those paragraphs, which further specify the multiple storage and/or the carriages and the embodiments thereof, which can be applied analogously in this invention, are specifically also incorporated.

Further advantages, features, and details of the invention follow from the description below, in which exemplary embodiments of the invention are described with reference to the drawings.

### BRIEF DESCRIPTION OF THE DRAWINGS

The list of reference numerals as well as the technical content of the patent claims and figures is a part of the disclosure. The figures are described coherently and comprehensively. Especially unless differentiated explicitly, the reference numerals and the descriptions thereof are to thereby be considered across the figures. Identical reference numerals represent identical components, reference numerals with difference indices specify functionally identical or similar components. Functional and logical connections of the used ranges of numbers are also obvious for the person of skill in the art. The drawings are symbolic illustrations. It goes without saying that all supporting parts are connected to one another in an expedient manner (e.g. via a frame constructions), even if this cannot be seen explicitly from the drawings in some places (e.g. for the improved recognizability of other features), in which:

FIG. 1a to FIG. 1i show schematic diagrams of different embodiments of a system according to the invention from a cable processing machine and the corresponding cable processing transport system,

FIG. 2a and FIG. 2b show an isometric view of the embodiment according to FIG. 1c, once with both cable transport units docked to the cable processing machine (FIG. 2a) and once detached (FIG. 2b),

FIG. 3a and FIG. 3b show a further detail view of FIG. 2b with some elements faded out for a better view onto the cable holders on a cable conveying device formed as conveyor belt,

FIG. 4a to FIG. 4d show different sectional and detail views for FIG. 2a and/or FIG. 2, with viewing direction onto the coupling and the docking mechanism, according to the arrows drawn in there, with some elements faded out for a better view onto the coupling and the docking mechanism,

FIG. 5a and FIG. 5b show a special embodiment of the cable transport unit for transporting wrapped cables, similarly as shown in FIG. 1e,

FIG. 6 shows an isometric view of a cable wrap conveying device or multiple transport means, respectively, for several suspension transport units, embodied here as walking beam,

FIGS. 7a to 7e shows the mode of operation of a multiple transport means with walking beam drive principle and rotative, preferably electric drive, and

FIG. 8a to FIG. 8f show the mode of operation of a multiple transport means with walking beam drive principle and translatory, preferably pneumatic drive.

FIG. 9 shows the interaction between a cable processing station, which rotates the cable, and the suspended cable offcut, which is present as cable wrap, as well as the rotatable storage thereof in the region of the suspension transport unit,

FIG. 10a shows a first exemplary embodiment of a suspension transport unit,

FIG. 10b shows a second exemplary embodiment of

a suspension transport unit,

FIG. 10c shows a third exemplary embodiment of a suspension transport unit comprising shaped element

FIG. 10d shows a fourth exemplary embodiment of a suspension transport unit comprising shaped element

FIG. 11a and FIG. 11b show a cable transport device comprising cable conveying device and suspension transport means in the case of cable offcuts, which are not present as complete wrap,

FIG. 12a to FIG. 12d show alternative suspension alternatives for a cable offcut on a suspension transport unit.

### DETAILED DESCRIPTION OF THE PREFERRED EMBODIMENTS

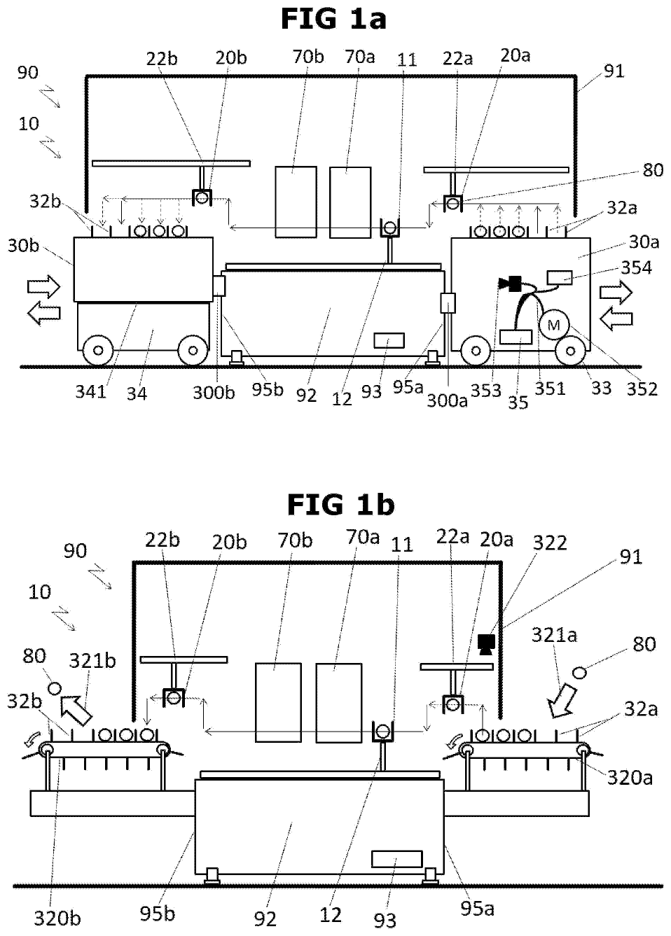

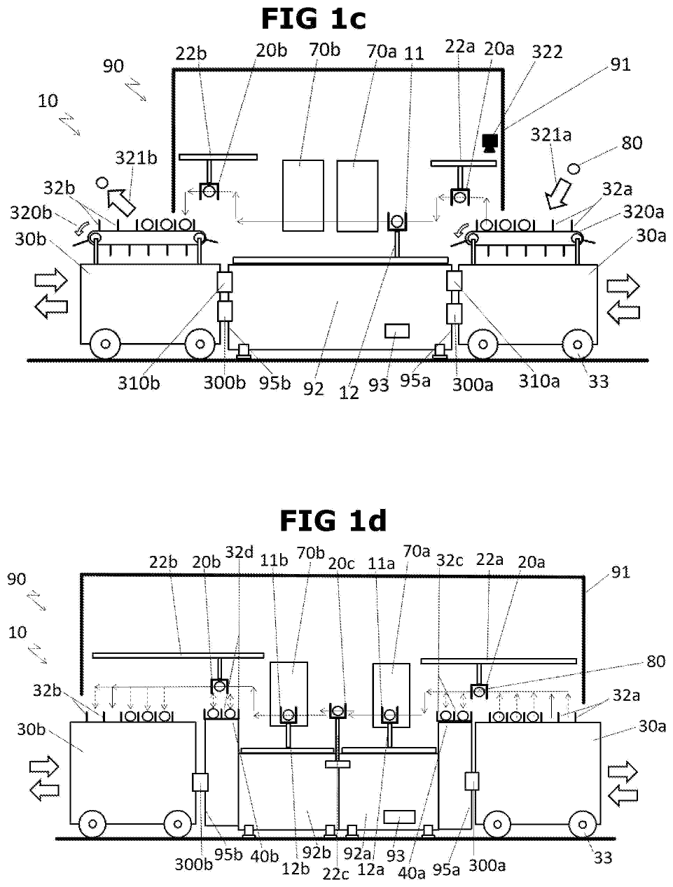

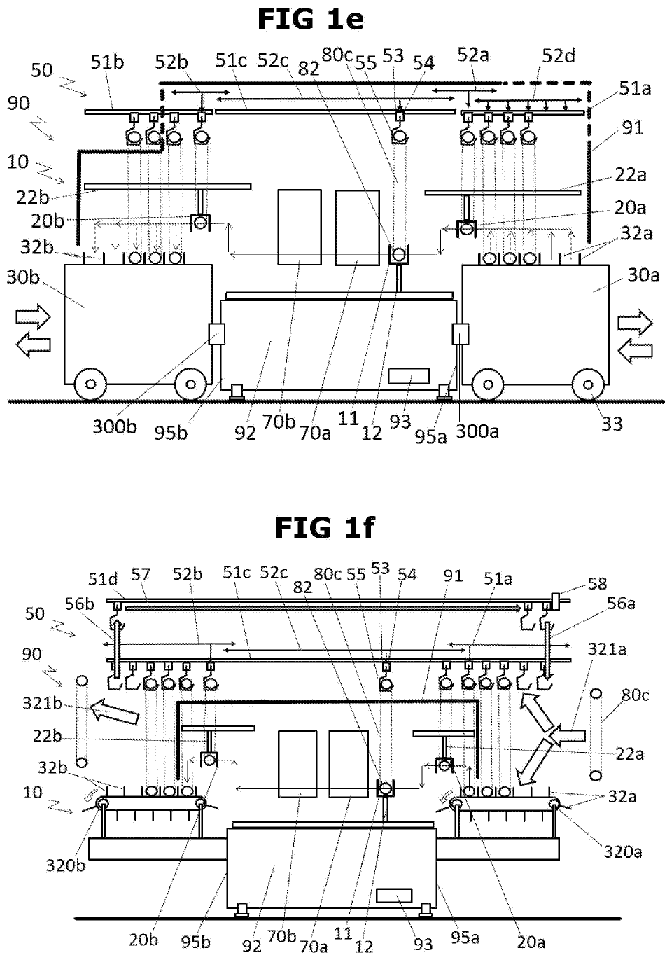

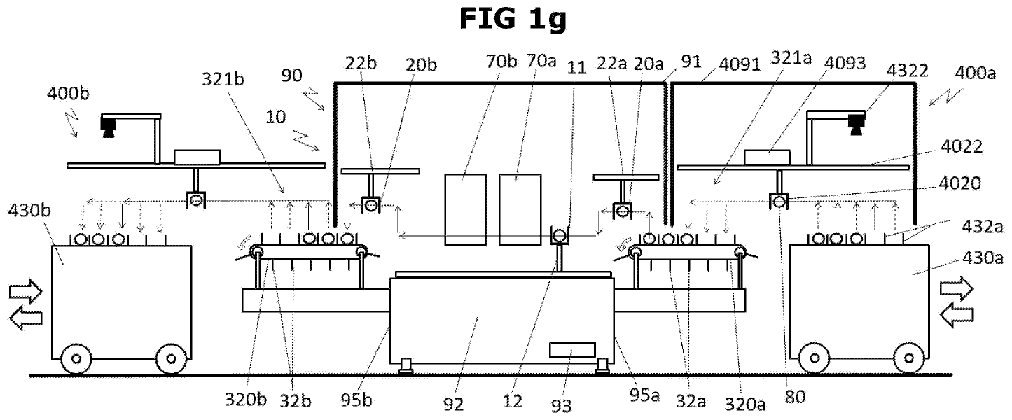

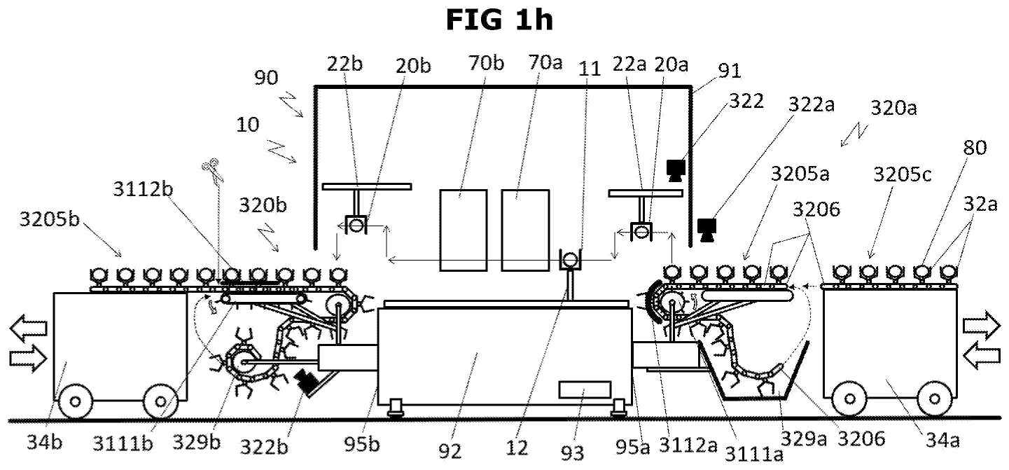

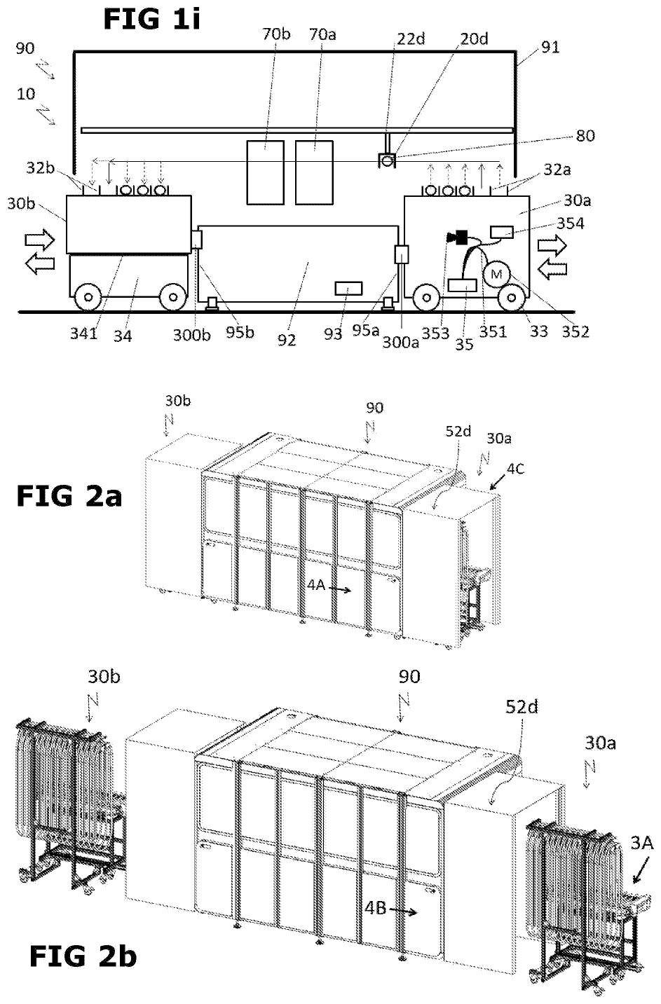

FIG. 1a to FIG. 1i show schematic diagrams of various embodiments of a system according to the invention of a cable processing machine 90 and the corresponding cable transport system 10, which extends to beyond the cable processing machine 90 in some embodiments. In the case of some of the figures, e.g., FIG. 1a to FIG. 1d or FIG. 1g to FIG. 1i, the suspension transport means 50 is faded out for the sake of clarity because the focus thereof is on embodiments of a transport of the cable end regions 82. However, the suspension transport means 50 is likewise present there, especially according to a embodiment described or claimed in this document, respectively.

In the embodiment in FIG. 1a, this cable transport system 10 consists of at least one transfer gripper 11, two delivery grippers 20a, 20b, the transfer mechanisms 12, 22a, 22b belonging to the grippers, and two groups of cable transport units 30a, 30b for transporting several cables 80. These cable transport units 30a, 30b are embodied as carriages or trolleys, respectively, and can move independently of the cable processing machine 90. The carriages 30a used for loading the cable processing machine 90 can thereby dock on the input side 95a of the cable processing machine 90, with the help of the docking mechanism 300a. The carriages 30b used for unloading the cable processing machine 90 can thereby dock to the output side 95b of the cable processing machine 90, with the help of the docking mechanism 300b. Depending on the embodiment, the carriages 30a and 30b can in each case be formed differently, thus specifically either for the input side 95a or for the output side 95b, or the carriages 30a and 30b can also be embodied similarly, so that the same carriage 30a, 30b can be used on the input side 95a or on the output side 95b.

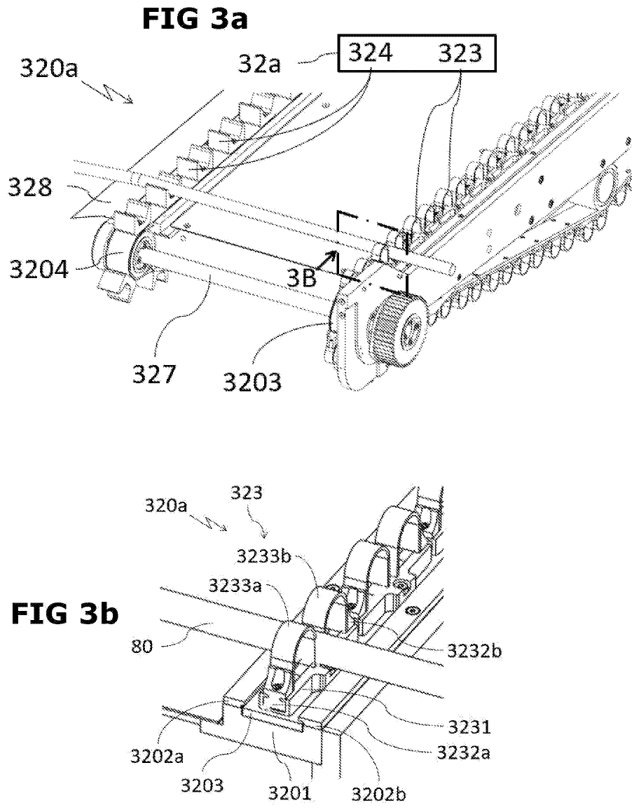

Several cable holders 32a, 32b are provided in each of the two carriages 30a, 30b. They can either be designed as simple separating webs (as drawn here in FIG. 1a) or supports 324 (as drawn in FIG. 3a), but also as spring-loaded cable clamps 323 (as drawn in FIG. 1h, FIG. 3a, and FIG. 3b). Several cable holders 32a, 32b are preferably used per cable 80, preferably as combination with a clamp 323 and a support 324, as shown, e.g., in FIG. 3a.

For processing the cables 80, they are removed one after the other from a cable holder 32a or a cable holder pair 323, 324, respectively, of the loading carriage 30a, by the first delivery gripper 20a. The delivery gripper 20a delivers the removed cable 80 to the transfer gripper 11, which supplies this to at least one, preferably at least two or more cable processing stations 70a, 70b for processing. In addition to the two grippers 20a and 11, the transfer mechanisms 12 or 22a, respectively, which in each case belong to them, also move for this purpose. After conclusion of all processing in the two cable processing stations 70a, 70b, which are illustrated in an exemplary manner here, the transfer gripper 11 and the transfer mechanisms 12 and 22b transfer the cable 80 to a further delivery gripper 20b in the region of the output side 95b, which then deposits or delivers it, respectively, into a cable holder 32b or a pair of two cable holders 32b of the unloading carriage 30b.

Alternatively, the depositing can also take place directly into a transport or packaging box for finished cables.

One cable 80 after the other can thus be processed fully automatically, until the loading carriage 30a is empty and/or the unloading carriage 30b is full—illustrated by means of the thin arrows, which illustrate the movement of the cables 80, wherein solid lines represent the current movement, and broken lines represent other possible movements. All grippers 11, 20a, 20b and the corresponding drive axes or transfer mechanisms 12, 22a, 22b, respectively, for the movement thereof are hereby part of the cable processing machine 90 and are connected to the controller 93 thereof, e.g. via various control cables (not illustrated). All transfer mechanisms 12, 22a, 22b as well as all cable processing stations 70a, 70b, . . . are fastened to the frame or rack 92, respectively, of the cable processing machine 90. In order to ensure the safety of the user, a housing 91 or another securing means, such as, a light curtain, for instance, etc. can be provided. This is embodied so that it covers at least the displacement region of all grippers 11, 20a, 20b and transfer mechanisms 12, 22a, 22b, but nonetheless does not obstruct the arrival and departure (represented by means of block arrows) of the carriages 30a, 30b. A safe loading and/or unloading of cables 80 can thus also take place during the operation of the cable processing machine 90.

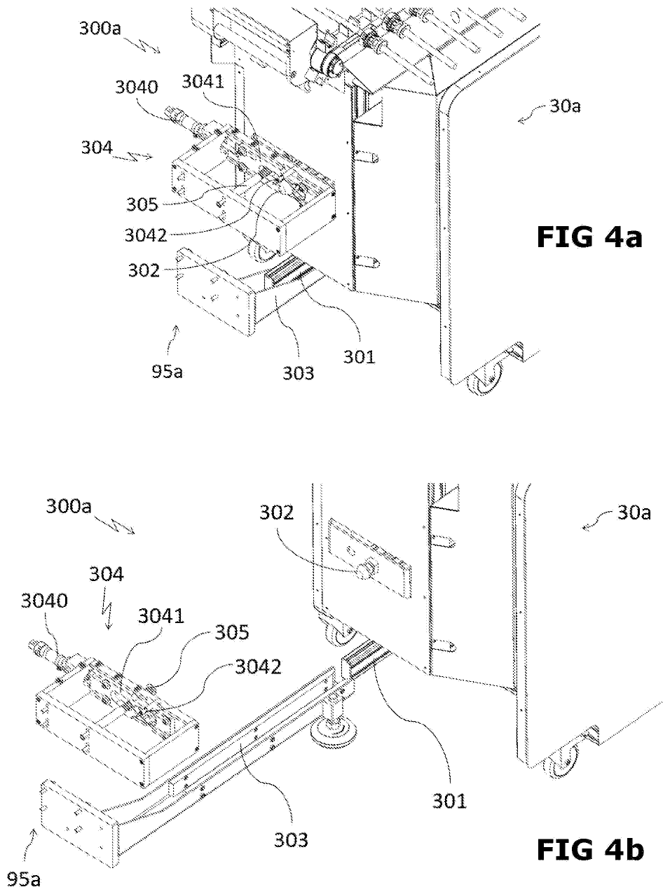

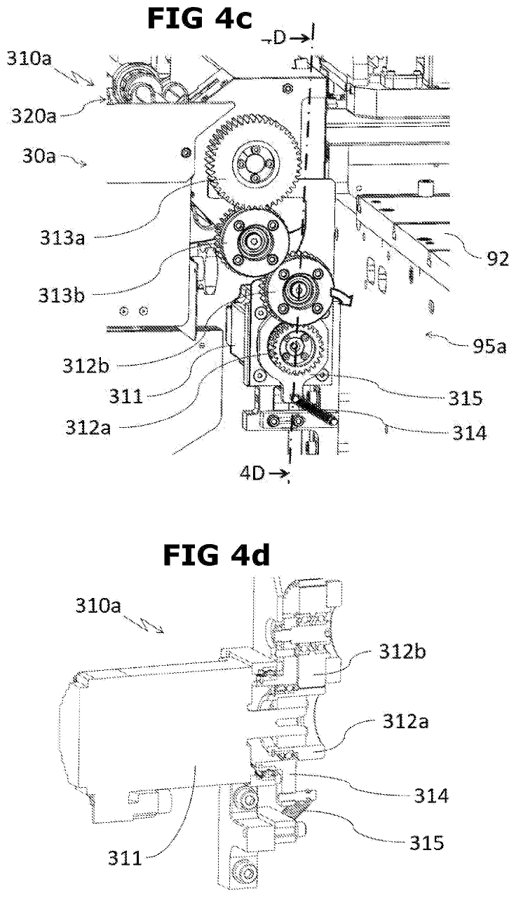

The docking mechanisms 300a, 300b are designed so that they provide for a simple and reliable docking of the carriages 30a, 30b to the cable processing machine 90 and also inform the controller 93 thereof, whether or not a carriage 30a, 30b is currently docked. The docking thereby preferably takes place with a defined position from the carriage 30a, 30b to the machine 90, so that a known removal or depositing position, respectively, is preferably given for the cables 80. Additionally or alternatively, such a position reference can be determined by means of sensors 3042 and can be provided to the controller 93 of the cable processing machine 90—as it is shown, for instance, in the exemplary embodiment in FIG. 4a and FIG. 4b. Additional sensors locking means 304 and/or mechanical guides 301, 303 or inlet surfaces, respectively, are preferably used for this purpose, which will be specified in more detail below.

The multiple storages 30a, 30b, thus the carriages 30a, 30b in the shown figure, can be embodied from very simple to “intelligent” or completely autonomously, respectively, in different embodiments, wherein the actual transporter 34 can be embodied so as to be capable of being separated from the multiple storage region with the cable holders 32a, 32b and/or from the docking mechanism 300a, 300b. An embodiment as intelligent carriage 30a is illustrated schematically in FIG. 1 on the input side 95a, for example comprising a separate controller 35, drive motors 352 for moving the moving elements 33, sensors 353 for the navigation, a power supply 354 and cables 351, which connect all of these elements, etc. The controller 35 can thereby be designed specifically so that it can communicate, preferably in a cable-free manner, with the controller 93 of the cable processing machine 90, the controller 35 of other carriages 30a, 30b, or a central overall controller. For example, cameras are used as sensors 353, preferably supported by further sensors and software methods, which provide information necessary for the (indoor) vehicle navigation (LIDAR, RFID, proximity sensors, guidance systems, IPS (“Indoor GPS”), triangulation methods, SLAM, etc.). A rechargeable battery (accumulator), which can in each case be charged, for example, in the docked state, preferably serves as power supply 354. The power supply for operating and charging can also take place in a cable-free manner or in a contact-free manner, respectively, via induction or collectors with sliding contacts.

In the case of ground-based carriages, wheels are preferably used as movement elements 33, ideally 4 per carriage 30a, 30b. Mecanum wheels with additional rollers in the wheel (e.g. as in U.S. Pat. No. 3,876,255) can be used, for example, for maximum maneuverability in confined spaces, driven by a motor 352 each, preferably an electric servomotor with gear. In addition, alternative drive principles can also be used, for example with balls, similarly as in old computer mice, classic wheels and rotary joints, and/or leg-like movement elements for overcoming steps and/or other obstacles. The carriages 30a, 30b can also be formed with wheels, which match rails, an air cushion support with matching drive and/or a magnetic levitation train. In addition to ground-based transport systems, the carriages 30a, 30b can alternatively also be formed in a ceiling- or wall-bound manner in other embodiments.

In minimal embodiments of carriages 30a, 30b according to the invention, drive elements and/or sensors can also be omitted completely. Such carriages 30a, 30b can be moved, for example, by the operating personnel itself and/or can be docked or undocked, respectively—e.g. similar to a shopping cart at the supermarket. Between this minimal and a fully autonomous embodiment, any intermediate stages of the carriages 30a, 30b can be formed and optionally also be used jointly in a plant.

It is particularly advantageous when the manufacturer of the cable processing machine 90 largely leaves this decision up to his customers and only provides the cable holder 32a, 32b and the docking mechanism 300a, 300b; comprising a simple and clearly defined mechanical interface 341 to the actual carriage 34, which can then be provided by the customer, depending on his needs, and can be equipped with afore-mentioned components. An embodiment of a setup of this type is illustrated schematically on the left on the output side 95b of FIG. 1a. The multiple storage 30b, especially the cable holders 32b and the carrier structure thereof comprising the docking mechanism 300b fastened thereto, is fastened to the transporter 34, for example via the easily releasable, mechanical interface 342. This transporter 34 can be obtained by the customer himself, e.g. as standard product and/or a transport system, which is already present, can be used. He can thereby decide for himself, whether very simple and cost-efficient transporters 34, which have to be pushed, are used, or whether intelligent carriages 35 comprising a controller, drive, and navigation are used, or whether a mixed operation thereof is to take place. If deciding on an intelligent carriage 35, a model from the same manufacturer can be selected, as is already used elsewhere at the same location, which is equipped, according to the invention, with the multiple storage 30a, 30b and, if necessary, with a mechanical or virtual/sensor-based docking mechanism. A later upgrade is also possible at any time, for example in that the cable holder 32b and/or the docking mechanism 300b are transferred to a motorized and/or autonomous transport system, e.g. with the interface 341. If the carriage 30a is changed directly after removal of the last cable and preferably still during the transport thereof through the machine, any standstill time of the machine 90 can be reduced or avoided therewith. Intermediate buffers 40a, 40b are preferably also used for this purpose, e.g. as will be shown later in FIG. 1d.

FIG. 1b shows an alternative embodiment according to the invention comprising a cable transport device 10, in the case of which the cable holders 32a, 32b are not mounted in a stationary manner on their carrier structure (as in FIG. 1a), but are embodied as a cable conveying device 320a, 320b—in the shown example, however, not mandatorily, on both sides of the cable processing machine 90. In another embodiment, the input side 95a, e.g., as shown, and the output side 95b comprising a simple storage of the completed cables in a transport box can take place, if necessary on a carriage 34 (not illustrated). The shown cable conveying devices 320a, 320b are a part of the cable processing machine 90 here, in particular firmly connected to the frame 92, and are controlled by means of the controller 93 thereof. Separate cable transport units 30a, 30b (as in FIG. 1), which can be separated from the machine 90, are not provided. The displacement path of the transfer mechanisms 22a, 22b for the transfer grippers 20a, 20b can thereby be formed correspondingly shorter, and the mechanical or virtual housing 91 likewise for personal protection against movable machine parts.

These cable conveying devices 320a, 320b are preferably embodied as conveyor belt, for instance as described in the example of FIG. 3a with at least one drive belt 3203, 3204 and cable holders 32a, 32b fastened thereto, preferably to a first belt 3203 embodied as clamp 323 and to a second belt 3204 embodied as support 324.

As described in more detail in the embodiment of FIG. 1h, chains 3205a, 3205b can alternatively also be used instead of belts 3203, 3204, preferably comprising chain segments 3206, which can be easily separated from one another, and especially comprising a drive 3111, which works even without tensioning of the chain 3205a, 3205b.

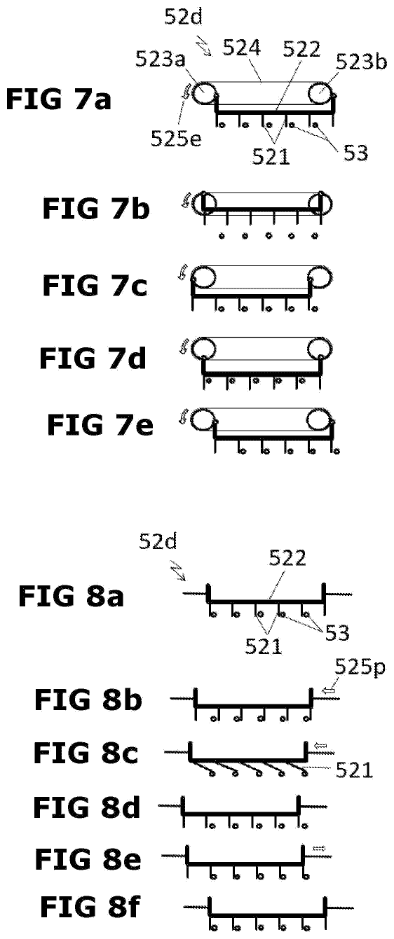

As described in FIG. 7 and FIG. 8, the cable conveying devices 320a, 320b can further also be embodied as walking beams—similarly to the multiple transport units 52d for the suspension transport units 53.

In the shown embodiment, the outer regions of the two cable conveying devices 320a, 320b can be accessed by the operator at any time. To load the machine 90, the operators place the unprocessed cables 80 or cable pieces, respectively, into the cable conveying device 320a on the input side 95a (illustrated by means of thick block arrow in the insertion region 321a) and remove the processed cables 80 from the cable conveying device 320b on the output side 95b (illustrated by means of thick block arrow in the removal region 321b) for this purpose. This can also take place during the operation of the machine 90, preferably not individually in each case, but in tranches, e.g. according to a warning message, when a fill level of the cable conveying device 320a or 320b is exceeded or fallen below. Corresponding sensors 322, preferably embodied as cameras or contact-free proximity switches, serve for this fill level measurement and/or several binary sensors (e.g. inductive sensors, capacitive proximity sensors, limit switches, light barriers, etc.) can also be present, the arrangement of which can vary, depending on the embodiment. Only the fill level sensor 322 on the input side 95a is illustrated here in an exemplary manner. Corresponding sensors 322 can also be provided on the output side 95b in the same way.

Due to this mode of operation, a single operator or robot can, for example, take over the loading as well as the unloading and/or can operate several machines 90. A carriage change and a standstill of the machine 90, which may be associated therewith, can be forgone. However, cables 80 have to be added and removed on a regular basis; in this specific embodiment in each case individually and directly at the machine 90—and not as carriage load, as in the case of the other embodiments, with several cables 80, which can also be loaded or unloaded from the carriage 30a, 30b away from the machine 90 and/or which can be further processed and/or package. However, a manual or automated loading and/or unloading 321a, 321b from or to a carriage, respectively, can also take place thereby. In the illustrated example, the transport of the cables 80 in the interior of the cable processing machine 90 takes place identically as in FIG. 1a, with the help of the grippers 11, 20a, 20b and the corresponding transfer mechanisms 12, 22a, 22b, from, to, and between the cable processing stations 70a, 70b, but can also take place according to one of the other of the embodiments shown here.

FIG. 1c shows an embodiment, which quasi combines the main features and thus the advantages of the two currently shown variations. The cable holders 32a, 32b are also fastened to cable conveying devices 320a, 320b here. In contrast to FIG. 1b, however, these cable conveying devices 320a, 320b are a part of cable transport units 30a, 30b, which move independently of the cable processing machine 90 and which can be docked and undocked thereon—e.g. similarly as the carriages in FIG. 1a.

Both modes of operation are thus possible in this embodiment during the loading and/or unloading process, thus the change of complete carriages 30a, 30b (as in FIG. 1a) and/or also the adding/removing of individual cables 80 from the cable conveying devices 320a, 320b (as in FIG. 1), as it is symbolized by means of the thick block arrows 321a, 321b or those in the case of the carriages 30a, 30b, respectively.

According to the invention, at least two options preferably lend themselves for the drive of the cable conveying devices 320a, 320b: The first option is a separate drive for this, directly on the carriage 30a, 30b, preferably connected to a separate controller 35 on this carriage 30a, 30b. This variation is advantageous in combination with intelligent carriages 30a, 30b (e.g. as in FIG. 1a, on the right), which already have a separate controller 35 and a power supply 354, and which can also be used for drive and/or navigation outside of the machine 90. If simple carriages 30a, 30b without a separate controller are used, the drive 311 for the cable conveying device 320a, 320b can thus preferably be part of the cable processing machine 90. Specifically, the drive for the cable conveying device 320a, 320b can take place similarly as in FIG. 3c or FIG. 4d, the schematic block 310a, 310b illustrated here can be formed specifically, e.g. with the individual elements 311, 312, 312b and/or 313a, 313b, which will be shown later. The power transmission to the cable conveying device 320a, 320b can thereby take place electrically, but preferably purely mechanically via a mechanical coupling 310a, 310b in the region n of the docking mechanism 300a, 300b. Specifically, but not only after the docking, a separate sensor or the same sensor 322, which is used for measuring the fill level, preferably embodied as camera, can be used for a calibration of the positioning of the drive or of the cables 80, respectively, with respect to the gripper 20a, 20b. In one embodiment, the two coupling halves 312a, 312b and 313a, 313b can be embodied, for example, as gearwheels or as a type of power take-off shaft, which are engaged with one another during the docking, e.g. as it is described in FIG. 4a and FIG. 4b.

FIG. 1d shows a system similarly to FIG. 1a, comprising two enhancements, which can be advantageous in particular in the case of very long cable processing machines 90. The cable processing machine 90 thereby consists of 2 or more modules, each comprising a rack 92a, 92b and a transfer mechanism 12a, 12b, which can be displaced over the entire rack or module length, respectively, comprising transfer grippers 11a, 11b fastened thereto. To deliver the cables 80 from the first transfer gripper 11a to the second transfer gripper 11b, a further delivery gripper 20c comprising a corresponding transfer drive 22c is provided. Due to this setup, two or more cables 80 can now be processed simultaneously in the machine 90, which improves the clock cycle. In other embodiments, the cable processing machine 90 can also have three or even more transfer grippers and also more matching delivery grippers and transfer drives. With standardized lengths for the racks 92a, 92b and the transfer mechanisms 12a, 12b fastened thereto for the transfer grippers 11a, 11b, a modularly configurable cable processing machine 90 can thus be provided for the transfer grippers 11a, 11b.

An intermediate buffer storage 40a comprising further cable holders 32c is additionally provided on the input side 95a. It is a part of the cable processing machine 90 or a module thereof, respectively, and is specifically formed to bridge the time of the carriage change. This is particularly advantageous when the carriage change takes longer than a processing cycle. During the normal operation, the delivery gripper 20a delivers the cables 80 removed from a cable holder 32a of the carriage 30a not only to the transfer gripper 11a, but also deposits some of them in a cable holder 32c of the input-side intermediate buffer storage 40a—until the latter is full. The filling of the intermediate buffer storage 40a thereby preferably takes place during wait times between the supplies of the transfer gripper 11a, which are preferably treated in a prioritized manner. As soon as all cables 80 are removed from the cable holders 32a of the carriage 30a, a signal sounds for the user to change the carriage 30a or the latter is changed automatically, respectively. During the carriage change, the cables 80 intermediately stored in the intermediate buffer storage 40a are delivered to the transfer gripper 11a. The cable processing machine 90 can thus continue to run without interruption. In the case of a sufficiently high storage capacity of the intermediate buffer storage 40a, which is in particular adapted to a duration of the carriage change, an interruption-free operation can thus take place.

A similar intermediate buffer storage 40b comprising the corresponding cable holders 32d can alternatively or additionally also be provided on the output side 95b—in analogous or reverse manner, respectively.

To monitor the current fill level in the intermediate buffer storages 40a, 40b, either all storage and removal processes can be stored in the control program and/or additional sensors can be used (not illustrated), preferably one per cable holder 32c, 32d and/or a camera system, which can be fastened, for example, to the transfer grippers 20a, 20b.

FIG. 1e shows an enhanced embodiment of an overall system for the processing of long, pre-cut cable pieces, which are wrapped in a space-saving manner to form a cable wrap 80c with at least one, preferably several loops or rotations. In addition to the cable transport device 10 for transporting the cable end regions 82, a suspension or wrap transport means 50, respectively, is provided here, comprising elements formed accordingly for this purpose in the cable processing machine 90 as well as in the two cable transport units 30a, 30b. At least one of the cable end regions 82 of the cable wraps 80c is inserted during the infeed and/or outfeed thereof into the cable holders 32a, 32b or is held by the grippers 11, 20a, 20b, respectively. The transport of the cable wraps 80c takes place with the help of suspension transport units 53, which are guided, e.g., in the guides 51a, 51b, 51c and which are actively moved by the transport means 52a, 52b, 52c, or which can optionally in each case also be dragged along by the gripper movements, if necessary. Each suspension transport means 53 thereby has a wrap or suspension fastener 55, respectively, embodied here as hooks, in which the respective cable wrap 80c is suspended. The suspension fastener 55 can thereby preferably be rotatably mounted in its suspension transport unit 53, for instance with the help of the shown rotatable storage 54. In the example shown here, the central guide 51c is connected to the cable processing machine 90, the two outer guides 51a and 51 are connected to the respective cable transport units 30a, 30b. The transport means 52a, 52b, 52c for the suspension transport units 53 are a part of the cable processing machine 90 and are connected to the controller 93 thereof. In the embodiment shown in an exemplary manner, they each have a linear drive axis comprising a guide as well as a follower part, which can be retracted and extended, matching to counter surfaces in the suspension transport units 53. They are arranged offset to one another and so as to overlap, so that an at least one-sided positive connection always exists between at least one transport means 52a, 52b, 52c and the suspension transport unit 53 during the delivery of a suspension transport unit 53 from one transport means 52a to the next 52c. The movements of the transport means 52a, 52b, 52c preferably take place largely synchronously with the movement of the transfer gripper 11 and/or of the delivery gripper 20a, 20b or the corresponding transfer mechanisms 12, 22a, 22b, respectively. It is thus ensured that the cable end regions 82 and the corresponding cable wraps 80 move virtually synchronously and cannot interlock with an adjacent cable wrap 80c.

In order to further improve the reliable resupply of cable wraps 80c from the loading carriage 30a, a special multiple transport means 52d can be provided there, also referred to as “cable conveying device”. In contrast to the simple transport means 52a, 52b, 52c, all suspension transport units 53 are moved or conveyed simultaneously on guide the rail 51a here, respectively, similarly as the cables 80 in the cable conveying devices 320a, 320b. This multiple transport unit 52d can also be embodied as conveyor belt, conveyor chain, or walking beam. The embodiment as walking beam is particularly advantageous thereby. Exemplary embodiments of such walking beams and the mode of operation thereof are described in FIG. 6, FIGS. 7a-e, and FIGS. 8a-f. All transport units 52a, 52b, 52c, 52d are a part of the cable processing machine 90. Alternatively, at least some of them can also be attached to the carriages 30a, 30b—as well as the corresponding guide rails 51a, 51b. A further multiple transport means can also be attached in the unloading carriage 30b. The fastening of the cable holders 32a, 32b to cable conveying devices 320a, 320b as part of the carriages 30a, 30b (e.g. as in FIG. 1c) is also a further embodiment here.

In order to realize the reliable resupply of cable wraps 80c in the loading carriage 30a completely without a separate drive, there are also other embodiments according to the invention. One of them is embodied with a passive force element, preferably embodied as constant force spring, which pushes the rearmost suspension transport unit 53 in the direction of the cable processing machine and thus also pushes all others further, similarly to the rounds in the magazine of a gun.

In one embodiment, the displacement region of the input-side transport means 52a can, for example, also be extended all the way into the region of the loading carriage 30a, and the latter is preferably equipped with at least one additional sensor and/or a corresponding mechanism, in order to move the next suspension transport unit 53 there - even if the position thereof is not defined exactly thereby, if necessary, and is slightly different each time. In a further embodiment, the multiple transport unit 52d can be part of the carriage 30a and can be mechanically coupled to the cable conveying device 320a for the transport of the cable end regions 82, wherein the drive thereof, in turn, can be part of the cable processing machine 90, for example with coupling 310a as drawn in FIG. 1c, FIG. 4c, or FIG. 4d.

The casing 91 is preferably embodied so that it does not obstruct the arrival and departure of the carriages 30a, 30b with the guide rails 51a, 51b fastened thereto and the cable wraps 80c suspended thereon, and nonetheless still protects the user against all dangerous movements of the cable processing machine 90, in particular also of the multiple transport means 52d.

FIG. 1f shows a further embodiment of an overall system for the processing of long cables, which are wrapped in a space-saving manner to form a cable wrap 80c. In the shown embodiment, no dockable mobile carriages 30a, 30b or transporters or extra carriages are used, but the cable wraps 80c with the corresponding cable end regions 82 are introduced individually into the cable processing machine 90 by the user, e.g. on cable conveying devices 320a, 320b, which are a fixed part of the cable processing machine 90 here, similarly as in FIG. 1b. For this purpose, the cable wrap 80c is suspended on the suspension fastener 55 of an empty suspension transport unit 53, and the corresponding cable end region 82 is placed or clamped, respectively, onto an empty cable holder 32a (or a cable holder pair, respectively) of the input-side cable conveying device 320a—illustrated by means of the thick block arrows on the right. The transport of the cable wraps 80c and of the corresponding cable end regions 82 as well as the processing thereof in the cable processing stations 70a, 70b can take place, e.g., analogously as in FIG. 1e. The completely processed cable wraps 80c can likewise be removed individually by the user again on the output side 95b.

A return system is provided for transporting the empty suspension transport units 53 from the output side 95b back to the input side 95a again. In the shown example, said return system preferably consists of a further guide 51d (preferably parallel to the first guide 51a), and end stop 58, a further transport means 57, as well as two lifts 56a, 56b. The output-side lift 56b thereby transports the suspension transport units 53 from the first guide 51a to the further guide 51d. There, they are transported with the help of the further transport means 57 into the region above the input side 95a, where they are stopped by means of the end stop 58 at a clearly defined position. The transport means 57 is preferably embodied as belt, wherein the suspension transport units 53 are transported with the help of frictional force transmission along the guide 51d, which preferably slips through in the region of the end stop 58. For this purpose, the suspension transport units 53 have a matching bearing surface, preferably spring-loaded with the help of a passive force element (not illustrated). The input-side lift 56a receives the suspension transport units 53 in the region of the end stop 58 and transports them from the further guide 51d back to the first guide 51a, above the input-side cable conveying device 320a.

Alternatively, the return can also at least partially take place by means of gravitation, e.g. by means of a guide, which is inclined with respect to the horizontal.

Alternatively, a design of the guide 51a as revolving rail, preferably in the shape of an oval, for conveying back to the input side 95a can also be used. For this purpose, the further transport means 57 required for this purpose as well as the carriages/slides/sliding bodies of the suspension transport units 53 have to be embodied to enable cornering. In return, the lifts 56a, 56b can be omitted.

FIG. 1g shows an enhanced overall system according to the invention, similarly as in FIG. 1b, in the case of which the loading and/or unloading takes place fully automatically. For this purpose, the system is enhanced with the automatic loading device 400a in the insertion region 321a and the automatic unloading device 400b in the unloading region 321b.

In the shown example, the automatic loading device 400a consists of at least one gripper 4020, a transfer mechanism 4022 moving said gripper, and a separate controller 4093. For differentiating purposes, this gripper 4020 is also referred to as external gripper 420. A loading carriage 430a comprising cable holders 432a fastened thereto and cables 80 located therein can be positioned in the region of this loading device 400a. This loading carriage 430a can be embodied similarly as the transport carriages 30a, 30b described in FIG. 1a and can optionally also be equipped with a docking mechanism (not drawn) for accurately positioning on the cable processing machine 90, preferably for a mechanical positioning, but alternatively also for a virtual positioning with a contact-free position detection via sensors. A camera 4322 preferably serves the purpose of monitoring the fill level. A separate housing 4091 of the loading and/or unloading device 400a, 400b can optionally also be provided. The complete loading device 400a can thereby in particular be designed so that it can be attached as quickly and easily as possible to the cable processing machine 90 and can also be removed again, in order to change between manual individual loading (as in FIG. 1b) and fully automatic carriage loading. In addition to a complete removal, the gripper 4020 can alternatively also be brought into a park position by means of the transfer mechanism 4022 with an opening or removing of the housing 4091, and can be deactivated together with it, and the insertion region 321a can be made accessible for manual operation.

In the fully automatic operation, the cables 80 are transported one after the other from the cable holders 432a of the loading carriage 430a into the cable holders 32a of the input-side cable conveying device 320b, with the help of the gripper 4020 and of the transfer mechanism 4022. The image of the camera 4322 supports thereby. In the case of a sufficient number of degrees of freedom in the transfer mechanism 4022 and corresponding intelligence of the control software for the interpretation of the camera image, a positionally accurate docking of the carriage and thus a docking mechanism can be omitted thereby. For this purpose, the transfer mechanism 4022 can be realized completely or partially with the help of a standard industrial articulated robot. All drive axes of the transfer mechanism 4022 and of the gripper 4020 are preferably designed with force measuring systems, further sensors, and a software, which are formed and certified for the collaborative operation, together with human beings. In the case of this design, a housing 4091 of the automatic loading device 400a can be omitted—as drawn on the left-hand side in the case of the unloading device 400b and the corresponding unloading carriage 430b. These elements are constructed similarly or identical, respectively, as the elements, which have just been described.

FIG. 1h shows a further option for providing the two operating modes of the individual loading (similarly as in FIG. 1b) and of the reloading of complete carriage loads of cables 80 (similarly as in FIG. 1a). For this purpose, the two cable conveying devices 320a, 320b are embodied with chains 3205a, 3205b instead of belts, the chain segments 3206 of which can simply be opened and closed or linked and separated, respectively, by the operator, preferably without tool or similarly as in the case of an energy chain/drag chain, respectively (e.g. by Kabelschlepp or Igus), ideally even in an automated manner by means of the cable processing machine 90. The drive 3111a, 3111b is thereby designed so that it can convey the chain 3205a, 3205b and the cable holders 32a fastened thereto with cables 80 fixed therein even when the chain 3205a, 3205b is not tensioned—similarly as, for example, in the case of retraction drives of crimp contacts or other expendable materials fastened to belts/chains in cable processing stations 70. For this purpose—as drawn on the input side 95a—a matching counter surface 3112a, which ensures the permanent positive connection between chain 3205a and drive wheel 3111a, can be provided directly opposite the drive wheel 3111a. This simple configuration is sufficient and expedient on the input side 95a, which only has to be pulled. Alternatively and especially expediently on the output side 95b—where the chain 3205b, which is loaded with cables 80, is mainly pushed—a specific drive 3111b is present, which uses a drive belt comprising internal and external teeth, instead of the drive wheel 3111a comprising teeth only, and a matching, straight counter surface 3112b. A drive of this type or a drive designed functionally similarly provides the advantage that it can be used in the linear part of the conveying section and can thus be placed at a location, at which the majority of the chain is still mainly pulled instead of pushed, whereby it is more process-reliable. Alternatively (not drawn), a simple drive identically to the input side 95a can also be installed on the output side 95b, and the chain 3205b can run in a guide, which prevents an unwanted buckling of the chain links during the pushing.

For a loading with a complete carriage load, an open piece of a chain 3205c can be inserted onto a transporter or transport carriage 34a and can be equipped with cables 80—which can also take place spaced apart from the cable processing machine. This transport carriage 34a is brought into the region of the input side 95a and a user or the machine connects the chain 3205c on the transport carriage 34a to the chain 3205a in the cable conveying device 320a—illustrated by means of the arrow between the chain segments 3206 on the respective ends of the chain 3205a on the machine and the chain 3205c on the transport carriage 34a.

The chain, which is thus lengthened or joined, respectively, now makes it possible to process all cables 80, which have been transported on the transport carriage 34a. During a carriage change, the machine does not need to be stopped—as, e.g., in the case of FIG. 1c—because a portion of the chain 3205a remains at the machine and provides a cable reserve for a change time of the transport carriage 34. A limitation to short cables as in the case of the magazine loading in FIG. 1f is also unnecessary thereby. Complex delivery grippers with corresponding transfer systems, as in FIG. 1g can thus also be omitted. In such an embodiment with separable chains 3205b, 3205a, 3205c, the connecting and releasing of the chain segments 3206 as well as the refilling and emptying of the regions below the cable conveying devices 320a, 320b can preferably take place manually in a simple way by a user and/or optionally at least partially in an automated manner.

The output side 95b can be formed functionally similarly thereby—but therefore in reverse order. The chain 3205b is not joined together by the user here, but pieces are severed in matching length, e.g. corresponding to the length of a transport carriage 34b—illustrated here by means of the arrow with the scissors symbol. In the case of a corresponding design of the separating and connecting mechanism in the chain segments 3206, an automatic separation can also be performed with the help of drives of the cable processing machine 90 (not illustrated). The transport carriages 34a, 34b can be designed very simply in a minimal configuration; a planar bearing surface and wheels are sufficient, optionally comprising rails or guides for the chain 3205b. A precise docking relative to the cable processing machine can also be omitted in simple embodiments, a means should simply prevent a pushing away of at least the output-side transport carriage 34b by means of the chain 3205b, for example by means of a foot-operated locking brake on one of the rolls, by hooking in on the machine etc. (both not illustrated).

For handling the empty chain segments 3206, chain reserve collecting means 329a, 329b are preferably provided under the cable conveying devices 320a, 320b, on the input-side preferably embodied as box 329a and on the output side preferably as roll 329b. The fill level thereof can be monitored by means of corresponding sensors 322b (only illustrated in an exemplary manner here at the output side 95b). In addition to these fill level sensors 322b and the cable fill level sensor 322, a further sensor 322a is preferably also provided on the input side 95a, which detects the end of an open chain 3205a and which generates a reloading and/or stop signal in this case.

Alternatively to the two chain reserve collecting means 329a, 329b on both sides, the chains 3205a, 3205b can also be connected to one another on both sides so that the empty chain links 3206 are conveyed from the input-side cable conveying device 320a to the output-side cable conveying device 320b.

If the chain segments 3206 are designed so that they also provide for a machine-based opening, the empty chain pieces on the input-side chain reserve collecting means 329a can also already be deposited so as to be prepared for the lengths matching the carriages 30a, 30b. The emptied chain links 3206, which are prepared in matching length, can also be deposited again on the transport carriage 34a on the input side directly in a lower carriage region (instead of in a chain reserve collecting means 329a). Analogously, a reserve of empty chain links 3206 on the output side can also be removed from a lower region of the carriage 34b (instead of from a chain reserve collecting means 329b). During a carriage change at a corresponding location (e.g. on the bottom and/or on the top), a manual or automatic connection and separation of the chain takes place in both cases. New as well as used chain links can thus be supplied and discharged with the carriage change.

For an improved fixation of the cables 80, the chains 3205a, 3205b are preferably embodied to be so wide that several cable holders 32a per cable 80 can be fastened thereto and/or several chains run in parallel (similarly as in the case of the belts 3203, 3204 in FIG. 3a). It can also be advantageous to only equip those chain links or chain segments 3206 (or only the respectively correct side there, respectively) with the mechanism for particularly easily opening and closing the chain connection—preferably as multiple link chain parts, the length of which match the carriages. Not only production costs can thus be saved, but it is also prevented that the user creates “unsuitable” lengths, which do not match the length of the transport carriages 34a, 34b. As already mentioned, such a mechanism can be designed so that, in addition or alternatively to a manual opening and closing, it also provides for an automated opening and closing. In embodiments with automated chain separation/connection, a fully automatic operation, e.g. with automatic carriage change and/or autonomously driving carriages can also be implemented.

In one embodiment, a cable conveying device 320a, 320b according to the automatic conveying system, which has just been described, comprising chains 3205a, 3205b can be formed so as to be capable of being retrofitted in a simple way into a “simple” operating mode for the loading and/or unloading of individual cables 80—similarly as, e.g., in FIG. 1b. This can take place, for example, in that the cable conveying device 320a, 320b is formed in such a way that the chain 3205a, 3205b can be provided as an above-described separated chain with open ends as well as so as to be joined to form a closed chain, formed especially with corresponding guides or paths (not illustrated) for the respective chain configuration, which can optionally be used and converted or modified. For example, a preferably manual joining of the chains 3205a, 3205b to form a closed loop or a loop can then take place—as it is optionally illustrated by means of the dashed arrows, whereby the cable conveying device is reconfigured to form a continuously revolving multiple storage, which can be individually loaded with cables 80 or unloaded, similarly as shown in FIG. 1b.

FIG. 1i shows a simplified configuration similarly as in FIG. 1a. The entire cable transport is realized here only by a single gripper, the transfer and delivery gripper 20d. A single transfer drive 22d belonging to the gripper 20d and thus the operating region of the gripper 20d thereby extends over the entire machine 90. The machine 90 is thus formed for a delivery-free cable transport by means of the one single gripper 20d from a multiple storage 32a on the input side, through the cable processing stations 70a, 70b, and to a second multiple storage 32b on the output side.

FIG. 2a and FIG. 2b show an isometric view of the embodiment as, for example, in FIG. 1c. In FIG. 2a with both cable transport units 30a, 30b docked to the cable processing machine 90 and in FIG. 2b released. The viewing direction for FIG. 4a and FIG. 4c are also illustrated in FIG. 2a or the viewing directions for FIG. 3a and FIG. 4b are illustrated in FIG. 2b—illustrated by means of the arrows 3A, 4A, 4B, and 4C.

The cable transport units 30a, 30b under the housing 91 of the cable processing machine 90 are illustrated only partially visible in FIG. 2a. The cables are thereby provided or removed, respectively, on carriages or cable transport units 30a, 30b. A common cable transport unit 30a, 30b for cable end region and corresponding cable offcut (or wrap, respectively), can thereby be used in each case, or they can be attached to respective separate cable transport units, which can optionally be coupled to one another.

In another embodiment, the cable can also be supplied so as to be suspended on a floor- or ceiling-bound cable transport unit for suspended cables to the cable processing machine, and the respective cable end regions can then be inserted there to a docked or fixedly mounted multiple conveying device, from which it is then picked up by grippers for processing purposes .

The supplied suspended transit units comprising the cables are thereby conveyed by a multiple transport unit 52d, preferably approximately synchronously to the corresponding cable end regions 82. The multiple transport unit 52d, which is not visible here under the cover, is thereby preferably a part of the cable processing machine 90 and is formed to engage with suspension transport units 53, which are guided in guides 51a of a cable transport unit 30a, 30b, and to convey them, e.g. as illustrated in FIG. 6.

FIG. 3a shows a detail view of FIG. 2a, according to the arrow 3A drawn in there, with some elements faded our for a better view onto the cable holders 32a and the cable conveying device 320a, which moves them, here embodied as conveyor belt. In the shown example, each cable holder 32a in each case comprises a clamp 323 and a support 324. The conveyor belt 320a consists of two belts or toothed belts 3203, 3204, which are driven via a common shaft 327. A common shaft (not visible) also exists on the opposite side in the region of docking mechanism 300a (see also FIG. 4a) and coupling 310a (see also FIG. 4c). In order to embody the two cable conveying devices 320a, 320b identically for the input side and the output side, gearwheels are preferably attached on both shafts.

The clamp 323 is fastened to the belt 3203 and the support is fastened to the other belt 3204. The cables 80 (only one of them is illustrated here) are thereby fastened in a clamp 323 each and the corresponding support 324, with the cable end to be processed in the region of the clamp 323. In order to prevent cables from getting and stuck adjacent cables from interlocking on the opposite side in the region of the support 324 even in the case of longer cables 80, a guide 328 is provided there, embodied here as sheet comprising a smooth bearing surface. Alternatively, an embodiment with several rolls can also be used.

Alternatively, supports 324 can also be used on both sides for very short cables 80, in order to simplify the insertion of the cables, which is advantageous during the fully automatic loading of the conveyor belt 320a—e.g. by means of a magazine loading means 60 from FIG. 1f. Clamps 323 can also be used on both sides. Instead of (toothed) belts 3203, 3204, chains 3205a, 3205b, 3205c can also be used, preferably comprising easily dividable chain segments 3206 and a drive 3111, which also works without chain tension, e.g. as described in FIG. 1h. Instead of two belts 3203, 3204 or chains 3205a, 3205b, 3205c, a wide belt or a wide chain can also be used, or also three or even several or a single correspondingly wide conveyor belt, respectively. If no clamps 323 are used in an embodiment, but only supports 324 (e.g. for very short cables), the use of a walking beam drive could also be used for the cable conveyance, e.g. similarly as used for the multiple transport means 52d for the suspension transport units 53 as described in FIGS. 7 and 8.

FIG. 3b shows a detail view of FIG. 3a, with section according to the sectional plane 3B drawn in there, through the belt 3203 and the guide elements 3201, 3202a, 3202b provided for it, embodied here with a plate 3201 and two sheets 3202a, 3202n. The cable clamps 323 are fastened to the belt 3203. They consist, for example, of two clamping jaws 3233a, 3233b each, two holders 3232a, 3232b, and a receptacle 3231. The two clamping jaws 3233a, 3233b are made of elastic material and are fastened to the two holders 3232a, 3232b, which are fixed here in a C-profile of the receptacle 3231. They form an “M”, similarly to the “golden arches” of the McDonalds logo, which is why these clamps are colloquially also referred to as “McDonalds clamps” and are known in similar form, for example also from tool clamping strips. In the shown embodiment, the preloading force of the clamping jaws can be set by displacing the holders 3232a, 3232b in the C-profile, matching the type and diameter of the cable 80. The receptacle 3231 and thus the cable clamp 323 is fixed to the belt 3203 via two screws, which are arranged transversely to the conveying direction thereof. It is thus made possible that the cable clamps 323 are moved around the corner without any problem at the shaft 327 (see also FIG. 3a). The fastening of the supports 324 on the belt 3204 (see also FIG. 3a) and also the guidance of this belt 3204 takes place analogously.

FIG. 4a to FIG. 4d show different sectional detail views of FIG. 2, with viewing direction according to the arrows 4A, 4C in FIG. 2a the arrow 4B in FIG. 2b, and the arrow 3D in FIG. 3c; whereby some elements are partially faded out, in order to have a better view onto the input-side coupling 310a and the input-side docking mechanism 300a. The input-side docking mechanism 300a is shown in an exemplary manner here between the input-side carriage 30a and the input-side 95a of the cable processing machine 90 but can alternatively or additionally and analogously or similarly also be attached in the region of the suspension transport means 50.

FIG. 4a and FIG. 4b show the input-side docking mechanism 300a. In FIG. 4a in the state “moved together and locked”—as in FIG. 2a. In FIG. 4b in the state “moved apart”—as in FIG. 2b. The viewing direction corresponds to the two arrows 4A, 4B, which are shown in FIG. 2a or FIG. 2b, respectively.

In the shown example of an embodiment, a locking pin 302 and a guide 301, here embodied as rectangular profile, is located on the carriage 30a. The matching counter pieces—the locking means 304 and the guide 304, here embodied as U-profile, are located on the input side 95a of the cable processing machine 90. The two parts of the guide 303, 304 are pushed into one another during the docking, and the carriage 30a is thus mechanically positioned or centered, respectively, accurately with respect to the cable processing machine 90. In order to compensate for inaccuracies at the beginning, spacious inlet surfaces are provided on both sides of the guide 303, 304. In order to increase the operating comfort and in order to avoid damages, a dampener 305 can additionally also be provided, here embodied as shaft with spring-loaded disk and fastened to the cable processing machine 90. If the carriage 30a is positioned correctly relative to the cable processing machine 90, this is detected by means of a sensor 3042, and the locking means 304 is activated. In the shown example, said locking means consists of a slide plate 3041 and a drive 3040, here embodied as pneumatic cylinder. For locking purposes, this slide plate 3041 is moved by means of the drive 3040. The operative areas thereof thus move into a groove in the locking pin 302 and thus establish a positive connection, which fixes the carriage 30a to the cable processing machine. To release this fixation, the slide plate 3041 moves out again. Exactly the same mechanism is installed once again on the output side 95b.

In another embodiment, the locking pin 302 and the dampener 305 can also in each case both be fastened to the carriage 30a, 30b or both to the cable processing machine 90. If they are both on the same side, they can also be formed as a common functional element (not drawn).

In other words, a cable transport carriage 30a or a coupling attachment for such a cable transport carriage is provided, in a partial aspect of the present invention, which is formed with a docking mechanism 300a, which has: a guide element, preferably formed as appendage comprising essentially parallel side surfaces, a preferably rotationally symmetrical locking pin 302 comprising a preferably wedge-shaped inlet geometry (chamfer) on the free end thereof, and a groove or diameter decrease (recess) behind the free end. In the alternative, a cable processing machine 90 or a functional module for such a cable processing machine is provided, which is formed with a docking mechanism 300a, which has: a tapering inlet region for side surfaces of a guide element of a carriage, at least one preferably circular opening for a locking pin 302 of the carriage comprising a locking unit 304 behind the opening, which is formed to hold the locking pin 302 in a positive manner in a locked position, and to release it in an open position, and comprising a run-on surface for a dampening element of the carriage, wherein the locking unit is preferably formed in such a way that an inserted locking pin 302 is locked automatically, and an unlocking device, which can be actuated in a controlled manner, optionally comprising a sensor for detecting a docked carriage. In addition to the above preferred embodiment, however, the person of skill in the art is also familiar with functionally similar embodiments of such a docking mechanism for the positioning and preferably also locking docking of carriages in different variations, for example comprising electromagnets or switching magnets.

FIG. 4c shows a further detail view of FIG. 2 with the viewing direction according to the arrow 4D drawn in there and some elements faded out for a better view onto the coupling 310a. In the embodiment shown in an exemplary manner, this coupling 310a is formed with a power transmission from the cable processing machine 90 to the multiple storage 30a, 30b. It is embodied as a group of several gearwheels 312a, 312b, 313a, 313b. The drive 311 is embodied as electric motor comprising a gear. It is fastened to the cable processing machine 90 and the first gearwheel 312a is flanged to its shaft. The second gearwheel 312b is rotatably mounted in the intermediate wheel holder 315, which, in turn, can rotate about the main axis of the drive 311 and which is preloaded via a passive force element 314. Depending on the cable conveying direction, one or several gearwheels 312a, 312b are once again also located on the carriage 30a, wherein one of them is connected to the conveyor belt 320a. As soon as the carriage 30a docks to the cable processing machine 90, the second gearwheel 312b comes into operative connection with the gearwheel 313a or the gearwheel 313b. In order to provide for the engagement at any time, thus also in the case of an unfavorable position of the gearwheels 312b, 313a, 313b to one another—i.e. “tooth-to-tooth”—the gearwheel 312b can bounce away slightly due to rotation of the intermediate wheel holder 315 and will be returned into the initial position again soon by means of the passive force element 314. The entire gear is thereby designed so that the drive torque in the preferred conveying direction points in the same direction as the operative direction of the passive force element 314. In the case of the input side 95a drawn here, the cable conveying device 320a conveys to the right, i.e. into the cable processing machine 90. The gearwheels 313a, 312b rotate clockwise, the gearwheels 313b, 312a rotate counter-clockwise. The drive torque thus supports the gearwheel 312b to move in the direction of the gearwheel 313b and thus in the direction of the engagement position.

On the output side 95b (not drawn), the conveying direction is the other way around, i.e. out of the cable processing machine 90. This is why no intermediate gearwheel 313b should thus be installed on the carriage side there, but the gearwheel 312b should come directly into operative connection with the gearwheel 312a.

FIG. 4d shows a sectional view of the main elements from FIG. 3c, according to the sectional plane drawn in there with the help of the arrow pair 4D. It can be seen once again there, how the gearwheels 312a, 312b and the intermediate wheel holder 315 are mounted to one another and rotatably to the drive 311.

A securing of the gearwheel or of the cable conveying device 320a, 320b, respectively, can optionally also take place - preferably coupled with elements of the docking mechanism 300a, 300b, for example with the locking means 304 or the sensor 3042 (FIG. 3a, FIG. 3b)—so that the cable conveying device 320a, 320b is blocked when the carriage is undocked and cannot be moved unintentionally. Additionally or alternatively to the camera or to the sensor 322, respectively (FIG. 1b), a position monitoring can also be present on the cable conveying device 320a, 320b and/or the cable processing machine 90, which is formed to determine a position of the cable conveying device 320a, 320b and thus of the cables 80 located therein, so that the cables 80 can always be gripped correctly or the cables 80 are always provided in a known position relative the to cable processing machine 90, respectively, regardless of how the gearwheels mesh (e.g. in the case of tooth-to-tooth or another displacement).

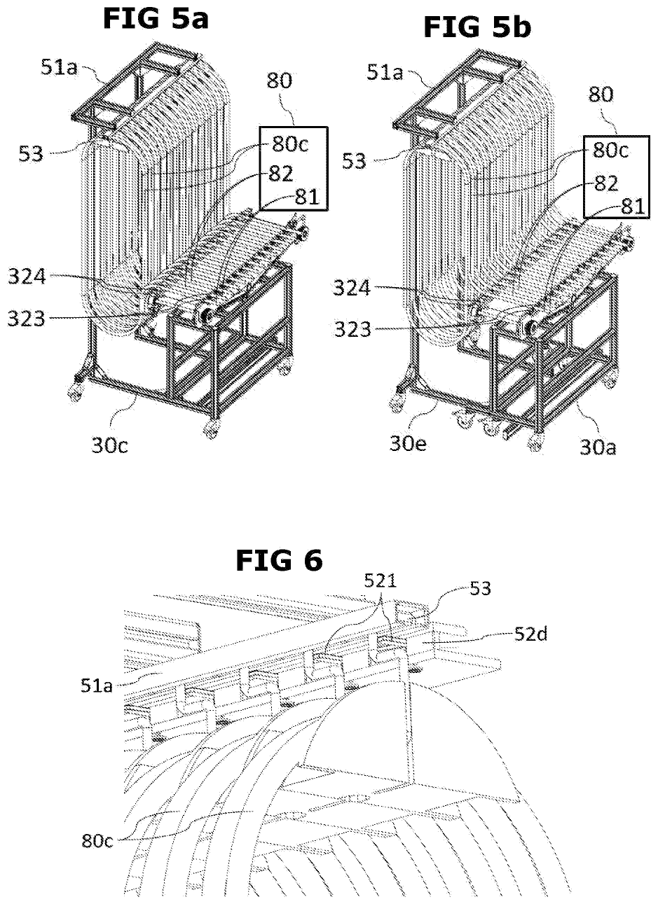

FIG. 5a and FIG. 5b show special embodiments of the cable transport unit 30a for the transport of wrapped cables 80c, similarly as sketched schematically in FIG. 1e. All cable wraps 80c are thereby suspended in a respective suspension transport unit 53, which are guided in the guide rail 51a. The cable ends to be processed are in each case clamped in a cable clamp 323 and are guided in the direction of the cable wrap 80c over a support 324—identically as also in the case of shorter, unwrapped cables 80 as in FIG. 3a.

FIG. 5a thereby shows a special configuration of the cable transport unit 30c, which also comprises the guide rail 51a.

FIG. 5b shows a further construction for the carriages for transporting the cable wraps 80c. The guide rail 51 for the suspension transport units 53 is thereby fastened to a separate suspension transporter or extra carriage 30e, which can be moved independently of the main carriage 30a. This main carriage 30a is preferably embodied identically as the carriages 30a, 30b, which are already used for shorter cables 80, as shown in FIGS. 2 to. 4. For the correct positioning of the extra carriage 30e, a further docking mechanism similar to 300a, 300b (not drawn) can be provided—either between the two carriages 30a, 30e or between extra carriage 30a and cable processing machine 90.

In addition to the small variety and complexity of the carriages, the embodiment with two separate carriages 30a, 30e also provides for a simplification of the operating mode “reload individually”. The main carriage 30a always remains docked thereby, the user brings the cable wraps 80c close by means of the extra carriage 30e and individually inserts the cable ends of the cable wrap 80c into the cable clamps 323. Similar carriages can be used on the unloading side as on the loading side.

Two basic options for how the cable wrap 80c can preferably be suspended are also illustrated. The rear outlet or the outlet of the cable wrap 80c facing away from the cable clamp 323, respectively, is clamped and processed in FIG. 5a; in FIG. 5b, the front outlet or the outlet facing the cable clamp 323, respectively. When using the rear outlet as in FIG. 5a, the cable 80 can be rotated more easily and with a smaller torque for the correct alignment for later processing. In return, however, the length of the cable, which is not fixed, is slightly longer between clamp 323 and cable wrap 80c, which can lead to the interlocking of adjacent cables or cable wraps 80c, respectively. Depending on the type of the cable and thus the torsional and flexural rigidity thereof, the user can select freely which type of suspension he preferably selects. To support the simple cable rotation, a rotary joint 54 (illustrated in FIG. 1e) is at least provided in each suspension transport unit 53.

In another embodiment, the cable conveying device (320a, 320b) can also be docked or fixedly mounted to the cable processing machine 90, so that the cables 80 are brought to the cable processing machine while suspended on suspension transport units 53 on the extra carriage 30e, and the cable ends 81 or the cable end regions 82, respectively, are inserted directly on the cable processing machine 90.

Alternatively, the cables 80 can also be suspended on the cable processing machine 90 on the suspension transport units 53.

FIG. 6 shows an isometric view of a cable wrap conveying device or multiple transport means 52d, respectively, for several suspension transport units 53, here embodied with walking beam drive. The multiple transport means 52d comprises several followers 521, arranged at a distance from the suspension transport units 53 on the guide rail 51a of the carriage 30c or extra carriage 30e, e.g. as in FIG. 5a, FIG. 5b. These followers 521 are designed so that they can transfer a force in a positive manner to the suspension transport units 53. In contrast to a conveyor belt (similar to 320a, 320b), the followers 521 of the walking beam do not rotate for the transport, but move back and forth at a specified distance, whereby they entrain or convey, respectively, the suspension transport units 53 only in one direction, and run back empty in the opposite direction. Exemplary drive variations are shown in the two following figures.

Alternatively or additionally, the cable conveying device 320a, 320b (for example in FIG. 1c) can also be embodied with a walking beam drive of this type, wherein the cables 80 are the conveyed instead of the suspension transport units 53 in this case. For this purpose, the entire walking beam drive could be embodied to be similarly wide or 2× parallel, respectively, e.g. as the currently described variations comprising conveyor belts or chains.

FIG. 7a to FIG. 7e show the mode of operation of a multiple transport means 52d with walking beam conveying principle and rotative, preferably electric drive 525e. For this purpose, two disks 523a, 523b rotate synchronously, connected via a chain or a toothed belt 524. The connecting beam 522, to which the followers 521 are fastened, is eccentrically fastened to these two disks 523a, 523b. Due to the parallelogram created in this way, the rotation of the two disks 523a, 523b creates a circular movement of the connecting beam 522 without it rotating, similarly as in the case of the fairground ride “flying carpet”. The length of the followers 521 and the distance between multiple transport means 52d and guide rail 51a is thereby selected so that the positive connection between the followers 521 and the suspension transport units 53 is created or released, respectively, in the regions, in which the movement component of the connecting beam 522 reverses along the conveying direction, visible in the partial figures a, c, and d. The suspension transport units 53 are thus conveyed counter-clockwise to the right in response to ration of the disks 523a, 523b (FIG. 7c to FIG. 7e) and the followers 521 are brought back to the starting point again during the remainder of the movement (FIG. 7a to FIG. 7c), without the suspension transport units 53 being disturbed thereby.

FIG. 8a to FIG. 8b show the mode of operation of a multiple transport means 52d with walking beam and conveying principle translatory, preferably pneumatic drive 525p and spring-loaded followers 521, in an exemplary embodiment. The followers 521 are also fastened to the connecting beam 522 here. However, the latter is only moved back and forth in the conveying direction, preferably driven by a pneumatic cylinder 525p. In order to not convey the suspension transport units 53 back again when bringing the followers back to their starting point (FIG. 8a to FIG. 8d), the followers 521 are rotatably mounted and spring-loaded in the connecting beam 522. As soon as they come into contact with the suspension transport units 53 (FIG. 8b) opposite to the conveying direction, they fold (FIG. 8c) and then unfold again when they have moved past or when the connecting beam 522 is located in the left end position (FIG. 8d), respectively. In the opposite direction, the rotatable storage does not permit any movement, which is why the suspension transport units 53 are entrained reliably in the conveying direction (FIG. 8d to FIG. 8f). The spring force in the rotary joint between follower 521 and connecting beam 522 is thereby selected so that a reliable fold-back is ensured (FIG. 8c to FIG. 8d) as well as an unwanted conveying in the wrong direction is prevented. For this purpose, the spring force has to be selected to be smaller than the static friction force between suspension transport unit 53 and guide rail 51a.

Alternatively to the passive spring-loading of the followers 521 in the connecting beam 522, they can also be actively moved transversely to the conveying direction, preferably by means of a further pneumatic cylinder or a cylinder pair, respectively, which preferably moves the complete connecting beam 522 transversely. The creation of the transverse movement via at least one slide guide is also conceivable.

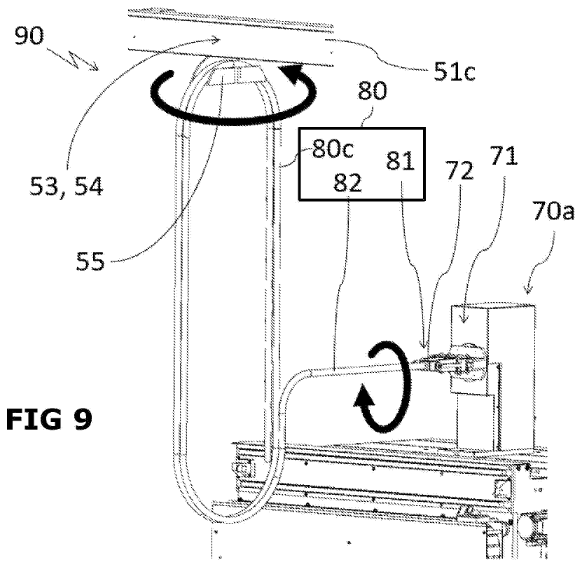

FIG. 9 shows the interaction between an exemplary cable processing station 70a, which rotates the cable end 81 to be processed or the cable end region 82 thereof, respectively, of an exemplary cable wrap 80c about the longitudinal axis thereof, in order to attain a desired rotational position or orientation for a processing or to perform a processing. According to the invention, the cable wrap 80c is thereby suspended in a suspension transport unit 53 comprising a rotatable storage 54. This cable processing station 70a can be constructed, for example, as described in EP 2 871 736, and can specifically comprise at least one sensor or a camera 71 (concealed by the cover), respectively, and a station gripper 72 comprising a corresponding rotary drive and/or specific gripper jaws, which provide for an unrolling of the cable end 81 in response to relative movement. The cable end 81 is thereby delivered, e.g., by the transfer gripper 11 (not illustrated here) to the station gripper 72, whereupon the transfer gripper 11 opens and releases the cable end 81 for rotation. With the help of a software-supported analysis of the camera image and/or of sensor data, the cable end is rotated about its axis with the help of the station gripper 72 and the rotary drive thereof—as illustrated by means of the rotary arrow—in such a way until it is optimally aligned in order to perform the next processing steps in this and/or the next cable processing station 70a, 70b.

After the rotation and/or the following processing, the cable end 81 is delivered to a transfer gripper 11 again and is further transported to the next cable processing station 70b. In order to prevent that the cable 80 rotates back again during these delivery processes between station gripper 72 and transfer gripper 11, the cable wrap 80c is suspended in such a way according to the invention that as little internal stress or elastic torsion energy as possible, respectively, remains in the cable 80. For this purpose, the suspension fastener 55 in this embodiment—as illustrated by means of the rotary arrow—is rotatably mounted with respect to the guide 51c or the suspension transport unit 53, respectively, especially via the storage 54. The rotation of the cable in the cable processing station 70a thus creates a rotation of the cable wrap 80c in the suspension transport unit 53 or suspension fastener 55, respectively—illustrated by means of the two arrows—which can eliminate the internal stress or unwanted torsion energy, respectively, as far as possible.

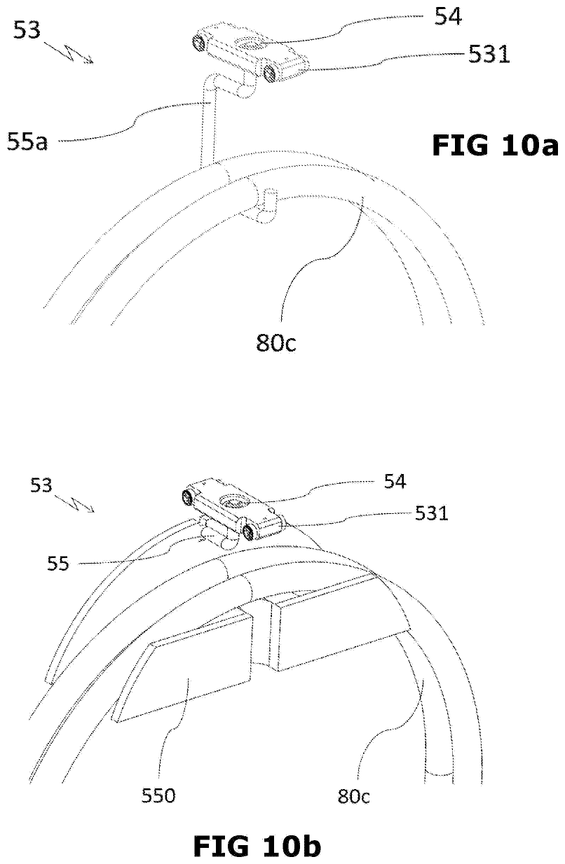

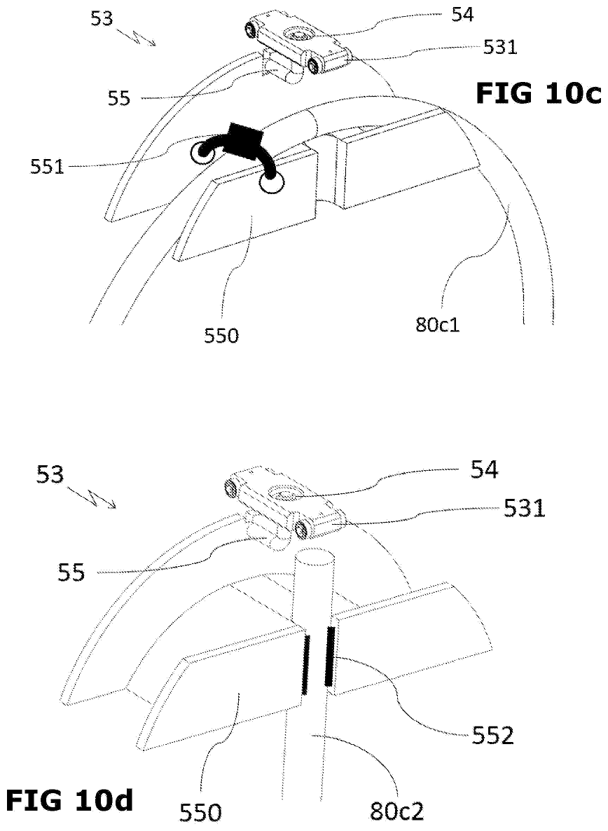

Depending on the cable length and/or cable type, a front or a rear outlet of the cable end 81 to be processed, thus a branching of the cable end 80 to be processed from the cable wrap 80c from the suspended upper or the lower bottom of the cable wrap—can be used, as shown in FIG. 5a or FIG. 5b. In FIG. 10, the front outlet (similarly as FIG. 5b) is illustrated here in FIG. 10 in an exemplary manner.

As shown in FIG. 10a, the cable wraps can also be suspended directly on a suspension fastener designed as hook 55a, i.e. without a shaped element 550 (FIG. 10b). The slide 531 (or carriage or trolley, respectively) provides a low-friction, displaceable guide in or on the guide rails 51a, 51b, 51c, 51d (FIG. 1e), for example by means of rollers, sliders, etc. The suspension fastener designed as hook 55a is rotatably mounted in this slide 531, via the storage 54, embodied here in an exemplary manner as pair of two ball bearings.

FIG. 10b shows the elements of another embodiment of a suspension transport unit 53. The shaped element 550 shown in this embodiment, which is fastened to the suspension fastener 55, preferably so as to be capable of being suspended or removed, as needed, can thereby serve for an improved shaping and or a reliable suspension of the cable offcut in the form of a cable wrap 80c. For this purpose, the shaped element 550 is preferably embodied in a curved manner, in particular with a curve radius, which is adapted to a bending radius of the cable wrap 80c, so that it is suspended in a stable manner. The shaped element 550 also preferably forms a U-profile at least in some sections, into which at least a portion of the cable wrap 80c can be inserted, in order to prevent a slide-down. This shaped element 550 preferably additionally also contains further holes and/or clips 552 for fixing half-wrapped cable offcuts 80c1 and/or simply suspended cable offcuts 80c2, as described in FIG. 10c and FIG. 10d.

FIG. 10c shows an exemplary embodiment according to the invention of a suspension of “half” or incomplete cable wraps 80c1, respectively, which is used in the case of “medium-length” cables, i.e. which are too short for wrapping but already too long for a transport without suspension transport unit 53, thus, e.g. lying flat in an unrolled state. In this context, FIG. 5a and FIG. 5b, for instance, also show a cable 80, which is already long enough to run at least once over or around the shaped element 550, but not yet long enough to shape a complete cable wrap 80c with several rotations. In order to thereby prevent the cable offcut 80c1 from slipping off the shaped element 550, it is temporarily fixed thereto, in the shown example via the clamping element 551. In its simplest form, this clamping element 511 can be embodied as cable tie, which preferably runs through one or several holes in the shaped element 550. Alternatively, a rubber band comprising hooks and/or a preferably two-piece clamping device comprising a ratchet, clasp, or similar clamping element can also be used, e.g. similarly as in snowboard bindings, climbing irons, or ski touring boots, etc. A similar clamping element 551 can optionally also be used in the case of real wraps with one or several rotations if something like this is required to secure the cable to the suspension transport unit.

FIG. 10d shows an embodiment according to the invention for shorter cable offcuts 80c2, especially those, which are not long enough to form a cable wrap 81c with outlet (as shown in FIG. 10a and FIG. 10b), but which are too long, for example, in order to be guided through the cable processing machine in stretched length in a practicable manner. According to the invention, they can be transported so as to be suspended perpendicularly, for example in that they are fixed to or in the shaped element 550. For example, in that the non-processed end of the cable offcut 80c2 is held in a holder 552 provided for this purpose, preferable by frictional engagement. As illustrated, a clamping element 552 can be formed, for example, on the shaped element 550, preferably as clip similar to a broomstick holder, as spring-loaded clamp, as loop or clamp for the S-shaped threading of the cable as in the case of a backpack carrier, etc.

Alternatively, a simple piece of cable tie (comprising corresponding holes in the shaped element 550, not drawn) can also be used in order to secure the cable offcut 80c2 against slipping off.

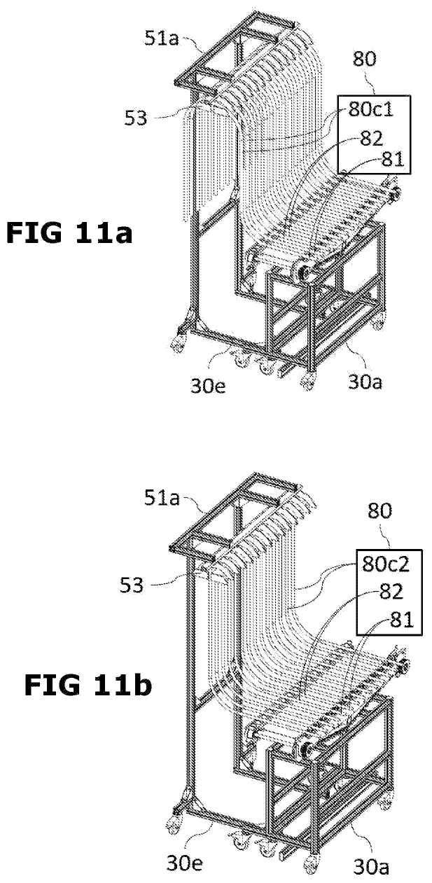

FIG. 11a shows an example of an embodiment, in the case of which cables 80 to be processed are provided on a floor-bound, mobile extra carriage 30e or transporter or multiple suspension transport unit for the cable processing system. The cables 80 can thereby be equipped on the extra carriage 30e, optionally also outside of the cable processing machine 90, thus on suspension transport units 53 in a guide 51a of the extra carriage 30e. Exemplary approximately medium-length cables 80 are shown in an exemplary manner here, which are approximately so long that the cable offcut 80c1 thereof (as the remaining piece of the cable 80 away from the cable end region 82 to be processed) can in each case be suspended above a suspension transport unit 53 and can be fixed there, as illustrated in FIG. 10c. This extra carriage 30e can then be provided on the input side 95a. The cable ends 81 or the cable end regions 82 to be processed, respectively, are thereby provided for the transport thereof in multiple storages 30a, 30b or cable conveying devices (320a, 320b), respectively, thus, e.g. fixed or clamped in defined positions, e.g. as described in FIG. 1e. The latter can thereby likewise take place on a second carriage 30a, as shown here, which can be formed separately from the extra carriage 30e or so as to be capable of being connected thereto.

FIG. 11b shows an embodiment, in the case of which the cables 80 are even shorter, so that a wrapping or suspension thereabove, as shown above, is not possible. These cable offcuts 80c2 are then suspended on the opposite end of cable end 81 on suspension transport means 53. The cable ends 81 are inserted in an exemplary manner into a multiple transport means here, wherein the already mentioned options with respect to carriage 30a and/or extra carriage 30e or the insertion, respectively, can be formed, in turn, here.

In the case of the two embodiments shown in FIG. 11a and FIG. 11b, the cable conveying device is fixedly connected to the cable processing machine or is permanently docked thereto, or the cables can be individually suspended on the suspension transport units, as described as alternative for FIG. 5b. The two transporters can also be formed as common transporter, as illustrated in FIG. 5a.

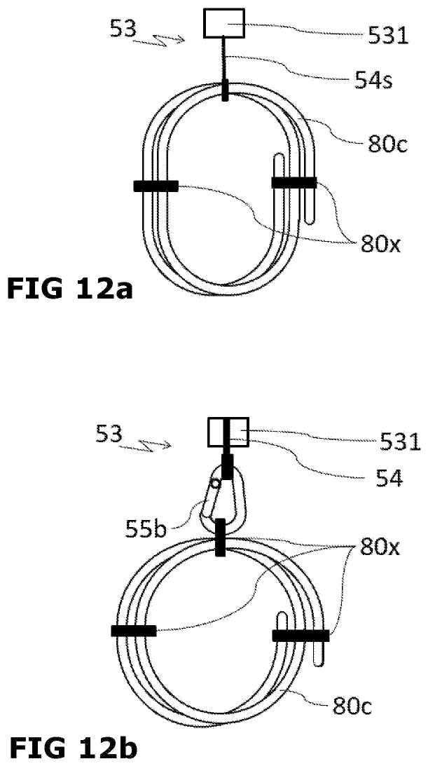

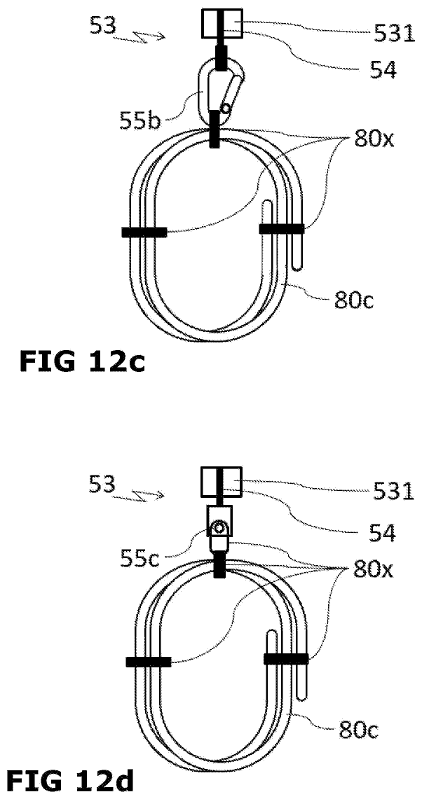

FIG. 12a to FIG. 12d show further alternative embodiments of examples according to the invention of suspension and tying alternatives for cable offcuts 80c, 80c1, 80c2.

The cable wraps 80c are generally preferably fixed at several locations in the circumferential direction by means of intermediate fixations or cable ties 80x, respectively, preferably as drawn with a total of three cable ties 80x (top, left, right), wherein the cable tie on the top can be omitted. Alternatively to cable ties 80x, other intermediate fixations can also be used, for example, tape, clips, or cord. The shape of the cable wrap 80c is either round (FIG. 12b) or in the shape of an oval or elliptical, respectively (FIG. 12a, FIG. 12b, FIG. 12d)—dependent on the cable type and the stiffness thereof; and also dependent on the wrap diameter and whether the cable wrap 80c was possibly compressed by the user from the round into the oval shape for space reasons. It is largely irrelevant for the function of the suspension transport means 50 described here, whether the shape of the cable wrap 80c is round or oval.

As shown in FIG. 12a, for example, a normal cable wrap 80c can also be fastened directly to the suspension transport unit 53 by means of a piece of rope or strip material, preferably enhanced by a clamping device similarly as described in the case of the variation for the clamping element 551 (FIG. 10c), in order to reduce the fastening effort (knots are no longer necessary). The rotatably mounting can also be omitted thereby, when the rope or the strip, respectively, are soft enough.

The end of a cable offcut 80c2, similarly as in FIG. 10d, can also be wrapped directly with a piece of rope and can be knotted, and can be suspended thereon. In the case of this rope embodiment, the shaped element and, if necessary, even a decided rotatable storage can then be omitted because the robe is formed to provide the rotatable storage, thus has a corresponding length, thickness and/or material selection.

FIG. 12b and FIG. 12c show embodiments, in which a carabiner 55b or a functionally similarly formed element is used instead of a hook 55a (FIG. 10a) comprising an optional shaped element 550 (FIG. 10b). This can take place with the opening leg either on the top—so that the carabiner can be suspended with cable wrap on the suspension transport unit 53 (FIG. 12c)—or with the opening leg on the bottom —so that the cable wrap can be suspended in a carabiner on the suspension transport unit 53. The suspension in each case takes place either by means of direct suspension of the carabiner 55b on the cable offcut 80c, 80c1 or on a cable tie 80x, which encloses the cable offcut 80c, 80c1, 80c2. The storage 54 is preferably provided via a pair of sliding or roller bearings, as drawn and described in FIG. 10.

Alternatively or additionally, a flexible suspension fastener 54s can, in turn, also at least partially take over the function of the storage here, similarly as shown in FIG. 12a.

As shown in FIG. 12d, the suspension fastener 55 can alternatively also be embodied with a preferably lockable pin 55c. For this purpose, an additional eye comprising cable ties 80x can be created on the cable wrap 80c, through which the pin is plugged or threaded, respectively. The rotatable storage 54 can be provided thereby by means of sliding or roller bearings in the region of the suspension transport unit 53 or at least partially also by the cable ties 80x suspended on the pin.

Combinations of the partial solutions described here are also possible and expedient, especially the extension with rope or strip material, respectively.

### LIST OF REFERENCE NUMERALS

3A-B, 4A-D arrow (pair) to the viewing direction/section definition
10 cable transport device
11, 11a-b transfer (gripper)
12, 12a-b transfer mechanism (several drive axes)
20a-c delivery (gripper)
20d delivery and transfer gripper
22a-d transfer mechanism (several drive axes)
30a-b multiple storage (cable transport unit, carriage, trolley, multiple transporter)
30c multiple storage comprising guide rail for suspension transport units
30e extra carriage, (cable) (multiple) suspension transport unit
300a-b docking mechanism
301 guide (male, profile)
302 locking element (locking pin)
303 guide (counter piece, female)
304 locking means
3040 locking drive (cylinder)
3041 slide plate
3042 sensor
305 dampener
310a-b coupling
311 drive (for conveying device)
3111a-b (chain) drive (wheel)
3112a-b counter surface
312a-b coupling half (gearwheel, drive side)
313a-b coupling half (gearwheel, conveyor belt side)
314 passive force element (spring)
315 intermediate wheel holder
32a-d cable holder (clamp, support, separating web)
320a-b (cable) conveying device (conveyor belt, walking beam)
3201 plate (guide element)
3202a-b sheet (guide element)
3203, 3204 belt
3205a-c chain (with easily separable segments)
3206 chain segment
321a insertion region
321b removal region
322 (cable fill level) sensor (camera)
322, 322a-b (chain segment) sensor (camera)
323 (cable) clamp
3231 (holder) receptacle
3232a-b (clamping jaw) holder
3233a-b clamping jaw
324 (cable) support
327 shaft
328 guide
329a-b (chain reserve) collecting means (box, roll)
33 movement element (wheel)
34 transporter
34a-b transport carriage
341 mechanical interface
35 controller (partially) autonomous driving system
351 (control) cable
352 drive (for proper motion)
353 sensor (camera)
354 power supply (battery, accumulator)
40a-b intermediate buffer storage (further cable holder)
400a automatic loading device
400b automatic unloading device
4020 delivery (gripper)
4022 transfer mechanism (robot)
4091 housing (casing)
4093 controller
4099 sensor (camera)
430a-b loading or unloading carriage (transporter, carriage, trolley)
432 cable holder (clamp, support, separating web)
50 suspension transport means (wrap transport means (coil handling)
51a-d guide, guide rail, rail
52a-c transport means (for 53)
52d multiple transport means (walking beam, conveying device)
521 follower
522 connecting beam (beam)
523a-b disk
524 toothed belt
525e (rotative) drive (electric)
525p (translatory) drive (pneumatic
53 suspension transport unit (slide, transport carriage)
531 slide (transport carriage)
54 (rotatable) storage
54s flexible suspension fastener (rope)
55 suspension fastener (hook)
55a hook (without shaped element)
55b carabiner
55c pin (comprising lock)
550 shaped element (suspension fastener)
551 clamping element (ratchet, rubber band, cable tie)
552 clamping element (clip)
56a-b lift (converter)
57 (further) transport means (return)
58 end stop (stopper)
70a-b cable processing station
71 sensor (camera)
72 (station) gripper (comprising rotary drive)
80 cable
80f (faulty) cable (inferior part, defective part)
80c cable offcut (cable wrap, coil)
80c1, 81c2 cable offcut (incomplete cable wraps)
80x intermediate fixation (cable tie)
81 cable end
82 cable end region
90 cable processing machine
91 housing (casing)
92, 92a-b frame (rack, module)
93 controller
95a input side
95b output side

1. A cable processing system comprising
a cable processing machine (90) comprising a machine controller (93) for automatically processing at least one cable end (81) of an in particular heavy and/or relatively flexurally rigid, pre-cut cable (80) in at least one cable processing station (70a, 70b) of the cable processing machine (90), and comprising
a cable transport device (10), which is formed for transporting the cable (80) comprising
a cable conveying device (320a, 320b) for transporting at least one of the cable ends (81) of the cable (80) into the at least one cable processing station (70a, 70b),
a suspension transport means (50), which is formed for the suspended transport of a cable offcut (80c, 80c1, 80c2) of the cable (80),
characterized in that
the suspension transport means (50) has
at least one guide (51a, 51b, 51c, 51d) and
several suspension transport units (53),
which are displaceable in the guide (51a, 51b, 51c, 51d), and which are formed as suspensions for the cable offcut (80c, 80c1, 80c2),
wherein the suspension transport units (53) are designed in such a way that a cable offcut (80c, 80c1, 80c2) suspended thereon can be rotated about a vertical axis with or on the suspension transport unit (53).

2. The cable processing system according to claim 1, characterized in that
at least one of the cable processing stations (70a, 70b) is formed to rotate the cable end (81) during or for the processing thereof about the longitudinal axis thereof,
preferably by means of a station gripper (72) comprising a rotary drive, and a sensor and/or a camera (71) for detecting the rotational position of the station gripper (72) or of the cable end (81), respectively, is and/or are further arranged in the region of the cable processing station (70a, 70b).

3. The cable processing system according to claim 1 or 2, characterized in that
at least one of the suspension transport units (53) is formed, comprising
a carriage or slide (531) matching the guide (51a, 51b, 51c, 51d),
a counter surface for a follower (521) of a transport unit (52a, 52b, 52c, 52d),
a rotatable storage (54) of a suspension fastener (55), which is preferably embodied in a hook-shaped manner, comprising a carabiner (55b) or as a pin (55c), to which suspension fastener (55) a shaped element (550) can preferably be attached.

4. The cable processing system according to one of the preceding claims, characterized in that
the suspension transport unit (53) is formed with a shaped element (550),
which is formed with a curved region and a region at least partially forming a U-profile in such a way that a subregion of the cable offcut (80c, 80c1) can be suspended thereabove,
and/or
which is formed with a holding region (552) in such a way that the cable offcut (80c2) can alternatively be fixed on its non-processed cable end so as to be suspended vertically, wherein the shaped element (550) is preferably formed in such a way that the cable offcut (80c, 80c1, 80c2) can be fixed to the shaped element (550) on at least one cable section by means of a fastening element (551),
wherein the shaped element (550) is in particular formed in such a way that it can be replaceably attached to the suspension fastener (55) of the at least one suspension transport unit (53).

5. The cable processing system according to one of the preceding claims, characterized in that
the at least one suspension transport unit (53) is formed with a suspension fastener (55), on which the cable offcut (80c, 80c1, 80c2) can be suspended directly or indirectly, and
which suspension fastener (55) is in particular designed in such a way that, in the suspended stated of the cable offcut (80c, 80c1, 80c2), the vertical axis essentially corresponds to an axis of symmetry of the cable offcut (80c, 80c1, 80c2).

6. The cable processing system according to one of the preceding claims, characterized in that
the suspension fastener (55) is formed in such a way that the cable offcut (80c, 80c1, 80c2) can be indirectly fastened thereto by means of a releasable fastening unit, preferably by means of rope (54s) or by means of carabiner (55b) or by means of pin (55c) or by means of cable tie (80x).

7. The cable processing system according to the preceding claim, characterized in that sufficient space is provided in order to receive the cable offcut (80c, 80c1, 80c2) as suspended cable wrap (80c).

8. The cable processing system according to one of the preceding claims, characterized in that
at least one active transport means (52a, 52b, 52c, 52d), which is formed so as to move the suspension transport unit (53) in the guide (51a, 51b, 51c, 51d), is provided on the cable processing machine (90) in the region of the guide (51a, 51b, 51c, 51d),
wherein this transport means (52a, 52b, 52c, 52d) is preferably formed with at least one follower (521) matching a counter surface in the suspension transport unit (53) and a transport drive for moving this follower (521) parallel to the guide (51a, 51b, 51c, 51d),
wherein in particular the transport drive is formed in such a way that the followers (521) move synchronously or at an average transport speed of the corresponding cable end (81).

9. The cable processing system according to one of the preceding claims, characterized in that
a multiple transport means (52d) is arranged on the cable processing machine (90) on an input side (95a) of the cable processing machine (90) in the region of the transporter guide (51a), said wherein multiple transport means is formed so that it effects an engagement of the multiple transport means (52d) with at least one of the suspension transport units (53), preferably during the docking of a multiple storage (30c) with integrated guide rail or during the docking of an extra carriage (30e).

10. The cable processing system according to one of the preceding claims, characterized in that
the multiple transport means (52d) has several followers (521) for at least one of the suspension transport units (53) each and is preferably formed with a revolving belt (524) or with a chain, respectively, with a twin belt conveyor, with a conveyor belt, or with a walking beam conveyor.

11. The cable processing system according to one of the preceding claims, characterized in that
the suspension transport means (50) is formed in such a way that at least one of the suspension transport units (53) is pushed further by means of the suspension transport units (53) adjacent thereto, in particular on the output side (95b) of the cable processing machine (90).

12. The cable processing system according to one of the preceding claims, characterized in that
the transport means (52a, 52b, 52c) is formed passively or without a drive, respectively, wherein the suspension transport units (53) can be pulled along or displaced, respectively, by the cable conveying device (320a, 320b) or by grippers (11a, 11b, 20a, 20b, 20c, 20d) of the cable processing machine (90).

13. The cable processing system according to one of the preceding claims, characterized in that
the transport means (52a, 52b, 52c) is formed with several adjacent transport means (52a, 52b, 52c), which are preferably designed in such a way that the displacement region thereof overlaps, and both adjacent transport means (52a, 52b, 52c) simultaneously come into operative connection with the suspension transport unit (53) in the region of this overlap, wherein in particular one of the cable processing stations (70a, 70b) comprises a respective corresponding station transport means, the displacement region of which overlaps with an adjacent cable processing station (70b, 70a).

14. The cable processing system according to one of the preceding claims, characterized in that
the cable processing machine (90) has an input side (95a) and an output side (95b), and
that the guide (51a, 51b, 51c, 51d)
protrudes from the input side (95a) and/or from the output side (95b) of the cable processing machine (90) in such a way that
the cable offcut (80c, 80c1, 80c2) can be suspended in the suspension transport unit (53) or can be detached therefrom, respectively, and/or
the suspension transport unit (53) can be inserted peripherally into the guide (51a, 51b, 51c) or can be pulled out, respectively, or pushed out from it, respectively.

15. The cable processing system according to one of the preceding claims, characterized in that
the guide (51a, 51b, 51c, 51d) is designed in such a way that empty suspension transport units (53) can be guided back to the starting point again,
wherein preferably
the guide (51a, 51b, 51c, 51d) is designed for this purpose as infinite loop, preferably in the shape of an oval, and/or that
the suspension transport units (53) can be transferred with the help of lifts (56ab) between different guides (51a, 51b, 51c, 51d).

16. The cable processing system according to one of the preceding claims, characterized in that the cables (80) can be supplied to the cable processing machine (90) so as to be suspended on a replaceable extra carriage (30e), which can be docked in such a way that a delivery of the suspension transport units (53) from a guide (51d) on the extra carriage (30e) into the guide (51c) of the cable processing machine (90) can be performed,
and wherein the cable end regions (82) of these cables (80) can be introduced into a cable conveying device (320a, 320b) on the cable processing machine (90),
wherein the cable conveying device (320a, 320b) is preferably a firmly installed part of the cable processing machine (90) or a multiple storage (30a, 30b), which is permanently docked thereto.

17. The cable processing system according to one of the preceding claims, characterized in that
for a conveyance of the cable offcut (80c, 80c1, 80c2) outside of the cable processing machine (90), the cable processing system has at least one floor- or ceiling-supported, mobile multiple storage (30a, 30c) and/or extra carriage (30e), which can be docked to the cable processing machine (90) in a defined position,
wherein the multiple storage (30a, 30c) and/or the extra carriage (30e) comprises at least one guide (51a, 51b) for the suspension transport units (53),
which guide (51a, 51b) is designed in such a way that, when the multiple storage (30a, 30c) is docked or when the extra carriage (30e) is docked, the suspension transport unit (53) can be delivered to the cable processing machine (90) between the guide (51a, 51b) of the multiple storage (30a, 30c) or of the extra carriage (30e) and the guide (51c).

18. The cable processing system according to one of the preceding claims, characterized in that
the multiple storage (30a, 30b) is equipped with cable holders (32a, 32b, 32c, 32d), into which at least one cable end (81) of a corresponding cable (80) can be inserted in each case, and wherein in addition to a delivery of the suspension transport unit (53), a delivery of the at least one cable end (81) can also take place between multiple storage (30a, 30b) and cable processing machine (90).

19. The cable processing system according to one of the preceding claims, characterized in that
the multiple storage (30a, 30b) is formed as cable conveying device (320a, 320b), which has several cable holders (32a, 32b, 32c, 32d),
wherein at least one of the cable holders (32a, 32b, 32c, 32d) has at least one web or follower, respectively, and/or can be formed as support (324) and/or as clamp (323), wherein one clamp (323) and one support (324) can preferably in each case be arranged in parallel on one or two belts (3203, 3204) or on chains (3205), which run synchronously to one another, and the clamps (323) have elastic elements, the preloading of which can be set, and which are fastened in receptacles (3231), which can be guided through guides (3201, 3202a, 3202b) along the conveying direction of the belts (3203, 3204) or along the chains (3205).

20. The cable processing system according to one of the preceding claims, characterized in that
the cable processing machine (90) is formed with cable holders (32a, 32b), and wherein at least one of the provided cable ends (81) of a corresponding cable (80), which hangs down from a suspension transport unit (53) of the docked multiple storage (30a, 30c) or of the extra carriage (30e) can be inserted into these cable holders (32a, 32b).

21. The cable processing system according to one of the preceding claims, characterized in that
a firmly mounted multiple storage (30a, 30b) and a firmly mounted suspension transport means (50) are attached to the cable processing machine (90), and that the cable transport device (10) is formed in such a way that the cables (80) can be suspended on the firmly mounted suspension transport means (50), and the cable ends (81) or the cable end region (82) of these cables (80), respectively, can be inserted or clamped, respectively, into the cable holder (32a, 32b) of the multiple storage (30a, 30b).

22. The cable processing system according to one of the preceding claims, characterized in that
the cable transport device (10) has at least one frame-supported, displaceable gripper (11a, 11b, 20a, 20b, 20c) for the cable (80) in the cable processing machine (90), and
the cable transport device (10) is equipped with a cable conveying device (320a, 320b), which is formed as multiple storage (30a, 30b) and which has several cable holders (32a),
wherein at least one of the grippers (20a) is preferably formed as delivery gripper, to remove one of the cables (80) after the other from the respective cable holder (32a, 32b) and to supply it to at least one further gripper (11a, 11b, 20b, 20c) as transfer gripper and/or to one of the cable processing stations (70ab), and
wherein the transfer grippers (11a, 11b, 20a, 20b, 20c) are formed so as to be capable of being moved by means of a frame-supported transfer mechanism (12a, 12b, 22a, 22b, 22c) in order to perform a delivery of the cable (80) from one cable processing station (70a) into another cable processing station (70b).

23. The cable processing system according to one of the preceding claims, characterized in that
the cable processing machine (90) comprising at least one gripper (20a, 20d) as delivery gripper, which can preferably be moved with the help of a frame-supported transfer mechanism (22a, 22d), is formed so as to remove one of the cables (80) after the other from the respective cable holder (32a, 32b) and to supply it to at least one of the cable processing stations (70a, 70b) and/or to a further gripper (11a, 11b, 20b, 20c), which further gripper (11a, 11b, 20b, 20c) is formed so as to be capable of being moved by means of a further frame-supported transfer mechanism (12a, 12b, 22b, 22c) in such a way that a delivery of the cable (80) into one of the cable processing stations (70a, 70b) can be performed.

24. A method for automatically processing heavy, long and/or flexurally rigid cables (80) in a cable processing machine (90) comprising a
provision of the cable (80), in particular as cable wrap (80c), in suspended form on a suspension transport unit (53) of a suspension transport means (50),
movement of the suspension transport unit (53) in at least one guide (51a, 51b, 51c, 51d) through the cable processing machine (90),
processing of at least one cable end (81) of the cable (80) in at least one cable processing station (70a, 70b) of the cable processing machine (90) by means of a
conveying of the cable (80) by means of a cable conveying device (320a, 320b) and/or by means of at least one gripper (11a, 11b, 22a, 22b, 22c) for transporting at least one of the cable ends (81) or cable end region (82) of the cable (80), respectively,
characterized by
suspending the cable (80c) on suspension transport unit (53), wherein the suspended cable is rotatable about a vertical axis, relative to the suspension transport unit (53).

25. The method according to one of the preceding claims, characterized in that
the rotatable storage takes place by means of a
suspension fastener (55) on a suspension transport unit (53), which can be displaced in a guide (51a, 51b), of the suspension transport means (50), on which suspension fastener (55) the cable (80) is suspended.

26. The method according to one of the preceding claims,
characterized in that
the provision of the cable (80) takes place locally on the cable processing machine (90) by means of suspension of the cable on a suspension fastener (55) of the suspension transport unit (53), preferably by means of a rotatable hook (55a), a carabiner (55b), a rope (55s), a pin (55c), or on a shaped element (550) attached to the suspension fastener.

27. The method according to one of the preceding claims,
characterized in that
the provision of the cable (80) takes place in suspended form of several cables on a respective suspension fastener (55) of the suspension transport unit (53), wherein the suspension fasteners (55) are provided in a guide (51a, 51b) on a mobile multiple storage (30a, 30b), and a docking of the multiple storage (30a, 30b) to the cable processing machine (90) takes place.

28. The method according to one of the preceding claims,
characterized in that
the provision of the cable (80) takes place with an insertion of the cable end (81) or cable end region (82) of the cable (80), respectively, into a respective cable holder (32a, 32b), in particular into a multiple storage (30a, 30b).

29. The method according to one of the preceding claims,
characterized in that
the insertion of the cable end (81) or cable end region (82) of the cable (80), respectively, preferably takes place locally on cable holders (32a, 32b) on the cable processing machine (90).

30. The method according to one of the preceding claims,
characterized in that
the insertion of the cable end (81) or cable end region (82) of the cable (80), respectively, takes place separately from the cable processing machine (90) on cable holders (32a, 32b) on the transporter (34a, 34b).

31. The method according to one of the preceding claims,
characterized in that
an active movement of the cables (80) takes place in the suspension transport means (50), preferably by means of an electric or pneumatic drive, by means of a delivery of a movement from a drive of the cable processing machine (90) to the suspension transport means (50), or by means of a constant force spring.

32. A method for rotating a cable (80) of a length of more than approximately 1.5 meters, about an essentially horizontal axis in a cable processing station (70a, 70b) of a cable processing machine (90), comprising
a gripping of a cable end (81) or cable end region (82) of the cable (80), respectively, and a
rotation of the cable end (81) into a provided position, characterized by
a suspended provision of the cable (80) on a suspension transport unit (53) of a suspension transport means (50), wherein the suspended cable (80) is rotatable about a vertical axis with respect to the suspension transport unit (53), wherein the cable (80) is preferably provided in the form of a cable wrap, in particular whereby a compensation of tensions takes place by means of the horizontal rotation of the cable end (81) by means of a vertical rotational movement of the remaining portion of the cable (80) on the suspension transport means.
